(19) United States
(12) Patent Application Publication
(10) Pub. No.: US 2026/0127025 A1
(43) Pub. Date: May 7, 2026

(54) INTEGRATING HIGH-PERFORMANCE COMPUTING CLUSTERS WITHIN A CLOUD-NATIVE CONTAINER ORCHESTRATION ENVIRONMENT

(71) Applicant: NVIDIA Corporation, Santa Clara, CA (US)

(72) Inventor: Carlos Arango Gutierrez, Bavaria (DE)

(21) Appl. No.: 18/940,426

(22) Filed: Nov. 7, 2024

(51) Int. Cl. G06F 9/48; G06N 3/0895

(52) U.S. Cl. CPC G06F 9/4881; G06N 3/0895

(57) ABSTRACT

A method receives a batch of one or more first job requests to be performed by a high-performance computing cluster. The batch of first job requests is received from a container orchestration platform. The batch of one or more first job requests are translated into one or more second job requests. The second job requests are interpretable by a scheduler corresponding to the HPC cluster. The second job requests are sent to the scheduler.

### TECHNICAL FIELD

At least one embodiment pertains to integrating high-performance computing (HPC) clusters within a cloud-native container orchestration environment.

### BACKGROUND

A cloud-native container orchestration environment is a system designed to manage, scale, and deploy applications packaged in containers across distributed computing resources. This environment uses orchestration tools like Kubernetes® to automate the deployment, scaling, and operation of containers. Cloud-native environments are optimized for cloud infrastructure, enabling applications to run across multiple servers, data centers, or cloud providers.

High-performance computing (HPC) clusters are collections of interconnected computers that work together to perform complex computations. HPC clusters are often used for tasks such as scientific simulations, large-scale data analysis, or artificial intelligence (AI) modeling. These clusters can use parallel processing, where many processors handle different parts of a task simultaneously. HPC clusters are typically designed to maximize computational power, memory, and networking capabilities to meet the demanding performance requirements of research, engineering, and scientific applications.

### BRIEF DESCRIPTION OF THE DRAWINGS

FIG. 1 is a system with a control plane and an HPC cluster.

FIG. 2 illustrates a system including a Kubernetes® control plane (KCP) and a Slurm® resource manager, according to one embodiment.

FIG. 3 is a flow diagram of an example method for operating an HPC cluster within a cloud-native container orchestration environment, according to at least one embodiment.

FIG. 4 is a flow diagram of an example method for translating data between a cloud-native container orchestration platform, such as a control plane, and an HPC cluster, according to at least one embodiment.

FIG. 5A illustrates inference and/or training logic, according to at least one embodiment of the present disclosure;

FIG. 5B illustrates inference and/or training logic, according to at least one embodiment;

FIG. 6 illustrates training and deployment of a neural network, according to at least one embodiment;

FIG. 7 is an example data flow diagram for an advanced computing pipeline, according to at least one embodiment;

FIG. 8 is a system diagram for an example system for training, adapting, instantiating and deploying machine learning models in an advanced computing pipeline, according to at least one embodiment.

FIG. 9 illustrates a computer system, according to at least one embodiment.

FIG. 10 illustrates a computer system, according to at least one embodiment.

FIG. 11A is a block diagram of an example generative language model system suitable for use in implementing some embodiments of the present disclosure;

FIG. 11B is a block diagram of an example generative language model that includes a transformer encoder-decoder suitable for use in implementing some embodiments of the present disclosure;

FIG. 11C is a block diagram of an example generative language model that includes a decoder-only transformer architecture suitable for use in implementing some embodiments of the present disclosure;

FIG. 12 is a block diagram of an example computing device suitable for use in implementing some embodiments of the present disclosure; and

FIG. 13 is a block diagram of an example data center suitable for use in implementing some embodiments of the present disclosure.

### DETAILED DESCRIPTION

Technologies related to integrating high-performance computing (HPC) scheduling within a container orchestration platform are described. Currently, there are significant challenges associated with interfacing container orchestration platforms, such as Kubernetes®, with high-performance computing (HPC) workload managers, such as Slurm® or Flux®. Container orchestration platforms are designed to manage containerized applications across distributed computing environments, focusing on scalability, flexibility, and rapid deployment of stateless services. By contrast, HPC workload managers are optimized to execute computationally intensive tasks that require precise scheduling and allocation of tightly coupled resources, often across large-scale supercomputing infrastructures.

One difficulty in integrating these systems lies in their differing scheduling models. Container orchestration platforms can operate using a scheduling model suited for horizontally scalable, stateless services, where workloads are typically managed in a way that allows flexible, on-demand resource allocation. HPC workload managers, however, are structured to support batch scheduling and parallel processing, where tasks often depend on a tightly controlled environment with synchronized resource allocation to meet specific computational requirements. This gap between traditional HPC schedulers and modern cloud-native container orchestration environments presents several challenges. Traditionally, system administrators manage two disparate environments (e.g., HPC and cloud-native), which each have respective tools, concepts, and workflows. Conventional solutions fail to provide a unified interface to manage HPC resources in a cloud-native manner, which results in inefficiencies and increased management overhead. Traditional HPC schedulers do not natively support constructs commonly found in cloud-native container orchestration environments, such as nodes, secrets, and configuration maps.

One reason why HPC clusters and cloud-native container orchestration control planes, such as Kubernetes® control planes, typically cannot be mixed stems from their fundamentally different approaches to user management and system configuration. In general, HPC clusters are traditionally set up using Unix-based systems that rely on lightweight directory access protocol (LDAP) for user authentication and management. LDAP provides a centralized directory service that stores user credentials and permissions, allowing users to access various resources within an organization using a single set of credentials. This method is prevalent in universities and academic institutions, where a user receives one email and corresponding credentials upon enrollment. These credentials grant access to the HPC cluster and other institutional resources, leveraging internal LDAP databases to maintain consistency and centralized control. In contrast, Kubernetes (and other cloud-native container orchestration environments) manages user access and permissions through a cloud-native approach using role-based access control (RBAC). In cloud environments, user permissions may be assigned based on roles that define what actions a user can perform within the Kubernetes cluster. Access is granted according to one's team, position, or the permissions delegated by a manager or team leader. RBAC allows for granular and dynamic control over resources, aligning with the scalable and often decentralized nature of cloud services.

One incompatibility arises because LDAP and RBAC represent two different paradigms of user management. LDAP is built around a centralized directory that is ideal for environments where users require consistent access across a stable set of resources, such as in academic HPC clusters. RBAC, on the other hand, is designed for environments where resources and access needs frequently change, requiring flexible and dynamic permission assignment. Integrating these two systems is challenging due to differences in authentication mechanisms, user identity management, and permission enforcement. LDAP relies on a hierarchical directory structure and standardized protocols for querying and modifying user information, while RBAC in Kubernetes uses roles and bindings defined within a cluster's configuration. Attempting to mix HPC clusters configured with LDAP and Kubernetes control planes utilizing RBAC on the same node can lead to significant conflict in user management and access control. The systems expect different methods of authentication and authorization, making it difficult to synchronize permissions and maintain security.

The absence of a unified interface between container orchestration platforms and HPC workload managers can lead to inefficiencies in resource utilization and increases operational complexity. Without a unified interface to integrate these different scheduling mechanisms, integrating HPC infrastructure within a container orchestration platform can result in suboptimal performance and hinder the computational effectiveness of the HPC infrastructure.

Aspects and embodiments of the present disclosure address the above-described problems and others by providing an interface between a container orchestration platform, such as Kubernetes®, and a workload manager of an HPC, such as Slurm® or Flux®. This interface may provide support for scalable, efficient, flexible deployment of diverse workloads to be assigned from the container orchestration platform to the HPC. According to embodiments, the interface may receive a batch of one or more first job requests to be performed by an HPC cluster. This batch of first job requests may include training one or more artificial intelligence (AI) models. The interface may receive the batch of first job requests from the container orchestration platform. Next, the interface may generate a second job request by translating the batch of first job requests. This second job request may be interpretable by the HPC workload manager. The interface may send the second job request to the workload manager to be completed by the HPC cluster.

According to embodiments, the present disclosure provides a unified cloud-native control plane that exposes constructs commonly found in cloud-native container orchestration environments to an HPC scheduler. Using the unified control plane, system administrators can operate HPC clusters using tools and interfaces common to cloud-native container orchestration environments, such as Kubernetes®. This can include the ability to apply Kubernetes®-based policies, monitor resource usage, and automate workflows across both cloud-native and HPC resources.

In some embodiments, the interface (which may be implemented within a cloud-native control plane) may be designed to be scalable and extensible, which may allow the interface to support various different HPC schedulers and integrate with multiple different cloud-native ecosystem tools. The interface may implement scheduling and resource management techniques that align HPC job scheduling with resource allocation instructions or protocols of the container orchestration environment.

According to embodiments, the interface may use custom resource definitions (CRDs) that represent HPC resources within the cloud-native container orchestration environment (e.g., Kubernetes). The interface may implement controller logic to manage the lifecycle of these CRDs, translating Kubernetes application programming interface (API) calls (e.g., job requests) into corresponding actions on the HPC scheduler. The interface may include a communication layer that facilitates secure and efficient data exchange between Kubernetes and the HPC scheduler. The interface may include monitoring and logging capabilities that provide visibility into operations of one or more of the Kubernetes or HPC resources.

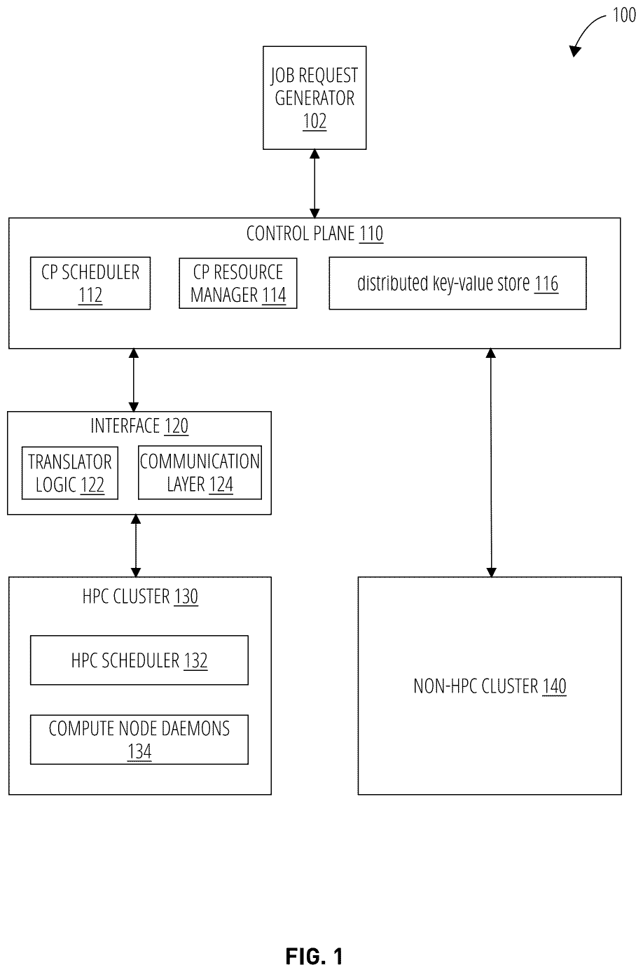

FIG. 1 is a system 100 with a control plane (e.g., master node) 110 and multiple worker nodes. In embodiments, an HPC cluster 130 represents one or more worker nodes, and a non-HPC cluster 140 also includes one or more worker nodes. The system 100 may include multiple HPC clusters 130 and/or multiple non-HPC clusters 140. In some embodiments, the HPC cluster 130 performs high-speed, intensive computations or tasks such as simulations and analysis, while the non-HPC cluster 140 supports tasks (e.g., general purpose tasks) that are less computationally demanding. The control plane may simplify complex tasks of managing large-scale applications by organizing containers into groups commonly referred to as pods and providing a framework for managing the containers and pods across clusters of machines. The control plane 110 manages and controls an overall state of an HPC cluster 130 and optionally of a non-HPC cluster 140, and may handle scheduling, health checks, and container deployment. A pod can contain one or more containers, and represents a single instance of a running application. Control plane 110 may offer service discovery, load balancing, and internal/external networking capabilities to allow communication between pods, nodes, and external clients. Control plane 110 may automatically scale applications horizontally by adding or removing pods based on demand, ensuring resource optimization. Control plane 110 may provide persistent storage (e.g., local storage, cloud storage, etc.), and can ensure that data is maintained even if pods are rescheduled or deleted. Control plane 110 can provide secure management of configuration settings and sensitive information (e.g., such as API keys, passwords, etc.) using configuration maps (resources that store configuration data that applications running in pods can consume) and secrets.

The control plane 110 may include a control plane (CP) scheduler 112, a CP resource manager 114, and a distributed key-value store 116 (an example of which is etcd). The CP scheduler 112 may be configured to determine the placement of workloads across various nodes or clusters (e.g., clusters treated as nodes) within a container orchestration environment. The CP scheduler 112 may take into account factors such as resource availability, workload demands, and predefined scheduling policies to optimize performance and resource utilization.

The CP resource manager 114 may be responsible for monitoring and managing the allocation of computational resources across the cluster. The CP resource manager 114 may ensure that resources are efficiently distributed and that workload requirements are met in compliance with established policies and constraints of the container orchestration environment. In at least some embodiments, the CP resource manager 114 may dynamically adjust resource allocations in response to changing workload conditions and resource availability. This may include adding and/or removing pods, nodes, etc. on demand as needed.

The distributed key-value store 116 may serve as a central repository for configuration data, state information, and metadata for the operation of the control plane 110. For example, the distributed key-value store 116 may store feedback from nodes or clusters about a status of a job or task. The distributed key-value store 116 may provide a data storage mechanism that supports high availability and fault tolerance. The distributed key-value store 116 may enable synchronization among the control plane components, which may help ensure that all parts of the system 100 have access to up-to-date information for decision-making processes.

In some embodiments, the control plane 110 operates within a Kubernetes® environment. In this context, the CP scheduler 112 may correspond to a Kubernetes® Scheduler, which assigns pods to nodes based on resource requirements and scheduling algorithms. The CP resource manager 114 may align with a Kubernetes® Controller Manager, which oversees the state of the cluster and manages controllers that regulate the lifecycle of pods and nodes. The distributed key-value store 116 may function as a primary datastore or database for the Kubernetes® system and maintain the cluster's desired state and facilitate coordination among the control plane components to achieve that state.

In some embodiments, the control plane 110 may be a Kubernetes-like control plane (KCP). Here, the control plane 110 may extend the capabilities of a traditional Kubernetes control plane to manage multiple clusters in a unified and centralized manner. Unlike a typical Kubernetes setup that oversees individual nodes within a single cluster, the control plane 110 may orchestrate workloads across multiple clusters, treating them as discrete, manageable units within a larger, overarching system. In other words, the control plane 110 may be a multi-tenant control plane configured to manage isolated clusters of resources. These isolated clusters of resources may be HPC clusters 130 or non-HPC clusters 140. This abstraction may allow the control plane 110 to coordinate resources, distribute workloads, and enforce policies across diverse clusters, much like a control plane for a single Kubernetes cluster would manage its nodes. By centralizing control, the control plane 110 can enable operators to treat entire clusters as logical units (sometimes referred to as “virtual clusters”), which simplifies multi-cluster management and enhances scalability, resilience, and workload distribution.

In at least some embodiments, the control plane 110 may implement custom resource definitions (CRDs) for each cluster that it manages. Custom resources (CRs) may provide consistency across different environments. According to embodiments, CRDs can extend the native capabilities of the control plane 110, and enable users and/or automated processes to define and manage CRs tailored to specific application needs or infrastructure requirements. CRDs can allow the control plane 110 to create, store, and manage resources beyond the Kubernetes® objects, such as Pods, Services, and Deployments, or resources beyond conventional objects of any other cloud-native container orchestration environment. By using CRDs, the control plane 110 can support unique workflows, complex configurations, and additional abstractions that cater to specialized use cases, often in multi-tenant or multi-cluster environments. This customization empowers KCP to act as a versatile, Kubernetes-compatible platform that can incorporate domain-specific objects and processes seamlessly, enhancing both scalability and flexibility in cloud-native infrastructure. The control plane 110 may enable users or automated processes to write any CR based on requirements set by a cluster (e.g., HPC cluster 130, non-HPC cluster 140, etc.) for which a user or automated process is enabling a capability. In embodiments where the HPC scheduler 132 is a Slurm®, a CRD may be implemented with a CR for the integration of the control plane 110 (which may be a KCP) with the Slurm® API.

According to embodiments, the control plane 110 can operate within cloud-native environments, such as in multi-cloud or hybrid cloud environments, where resources may span different cloud providers or on-premises infrastructure. Through this abstraction, the control plane 110 can allow these distributed clusters to be managed with a Kubernetes-native interface, preserving familiar Kubernetes APIs and tooling while remaining compatible with different types of infrastructures. This means operators (e.g., system administrators, users, automated processes) can deploy applications, enforce policies, and monitor resources across clusters as if they were managing a single environment, reducing complexity and improving consistency.

Job requests sent to the control plane 110 can define tasks to be executed with specific workloads within the container orchestration environment. These requests may originate from a job request generator 102, which may automatically produce these job requests based on system conditions, scheduled routines, or application demands. Alternatively, these job requests can be manually submitted by users such as system administrators. The job requests may arrive individually or in batches, allowing the control plane 110 to process multiple tasks concurrently and optimize resource utilization across the cluster.

These job requests can include a variety of information. For example, job requests can include, but are not limited to, container images, arguments for entry point of container images, environment variables, and/or resource requirements. Container images can encapsulate the runtime environment needed to execute a task. These container images may be lightweight, standalone packages that bundle an application and its dependencies, including system libraries, binaries, and configuration files. This isolation ensures that jobs can run consistently across different environments, reducing conflicts due to varying dependencies or software versions. When a job is submitted, a container image can serve as the executable codebase, providing the exact environment required to run the specified workload.

Arguments for an entry point of container images can specify commands or options to guide the container's execution when it starts. The entry point, typically a script or executable, can be defined within the container image to launch the main application or process. By passing arguments at runtime, job requests can modify how this entry point behaves, allowing flexibility in configuring tasks based on specific needs without modifying the container image itself. These arguments may control aspects like input data paths, operational modes, or verbosity levels, which allows for customizable container execution to fit different job requirements.

Environment variables can also be included in job requests, providing a way to inject specific values into the runtime environment of a container. Environment variables can act as global variables accessible throughout the container, enabling configuration without altering the underlying code. These variables can set paths, specify API keys, define settings like log levels, or control other application-specific configurations, ensuring that containers can run with the appropriate settings in different deployment scenarios. By adjusting environment variables, job requests can be tailored to match various operational conditions.

Resource requirements can also be included in job requests. Resource requirements may correspond to a submitted workload that is related to the job request. According to embodiments, resource requirements can define target amounts of computational and memory resources that a submitted workload may need to operate effectively. These resource requirements can include specifications for CPU cores, memory, storage, GPU resources, or the like. When a job request includes these resource requirements, the scheduler or orchestration system (here, the control plane 110) can allocate appropriate resources, optimizing for efficiency and performance.

When the job request(s) are received, the control plane 110 interprets the job request(s) to determine the necessary actions for workload deployment, scaling, and/or management. Batch processing of job requests may enable the control plane 110 to make holistic scheduling and resource allocation decisions, considering the collective needs of all pending tasks. Whether automatically generated or user-submitted, each job request may include parameters such as resource requirements, priority levels, and execution constraints, guiding the control plane 110 in orchestrating the workloads to meet operational objectives. Certain job requests may be better handled within an HPC environment, such as those involving complex scientific simulations, large-scale data analytics, or intensive computational tasks like genome sequencing and machine learning model training. These workloads can demand significant processing power and specialized hardware, which may exceed the capabilities of standard container orchestration clusters (or cause unnecessarily long runtimes). In such cases, the control plane 110 may be able to identify these resource-intensive job requests and assign them to an HPC cluster optimized for high-performance tasks. In some cases, these resource-intensive job requests may already include instructions to be assigned to an HPC cluster (e.g., if a certain job request has a simple Linux utility of resource management (Slurm®) annotation, or an annotation for another resource management scheduler or controller used with HPC clusters).

An interface 120 may be between the control plane 110 and the HPC cluster 130. The interface 120 may include translator logic 122 and a communication layer 124. According to embodiments, the interface 120 may be at least partially implemented in a cloud-native container orchestration environment along with the control plane 110. For example, the interface 120 may be at least partially implemented within the control plane 110 (sometimes referred to as a control plane node).

The interface 120 may be at least partially implemented within a login node of the HPC cluster 130. In an HPC cluster, the login node may serve as an entry point for users to access the system, typically providing a secure interface for submitting job requests, managing workloads, and interacting with various resources. While not responsible for direct workload execution, the login node may enable users (e.g., system administrators) or automated processes to configure and monitor tasks within the HPC cluster. The login node may also provide access to shell environments and other tools for preparing workloads before they are handed off to the control plane for scheduling and resource allocation.

The translator logic 122 may perform translation operations between the control plane 110, which operates within the cloud-native container orchestration environment, and the HPC cluster 130. Conventionally, job requests or other messages from the control plane 110 may not be interpretable by the HPC cluster 130, and vice versa. The translator logic 122 may perform operations that configure job requests or other data from the control plane 110 to be interpretable by an HPC scheduler 132 (or other component of the HPC cluster 130). Similarly, the translator logic 122 may perform operations that configure job status information or other data from the HPC cluster 130 to be interpretable by the control plane 110. Translator logic 122 may include information on APIs, accepted instructions, protocols, etc. understood by the HPC cluster, as well as APIs, accepted instructions, protocols, etc. understood by the container orchestration environment (e.g., by control plane 110). Translator logic 122 may use such information to translate between instructions and data associated with control plane 110 and instructions and data associated with HPC cluster 130 in embodiments.

In at least one embodiment, the control plane 110 may receive or generate one or more first job request(s). These job request may be received or generated with the intention to perform the workloads corresponding to the first job request(s) using the HPC cluster 130. These first job request(s) may include fields such as kind, metadata, spec, and/or status fields. The kind field can specify the type of job object, such as a Kubernetes® “Job” or “Pod.” The metadata field can contain information like the name, namespace, labels, and/or annotations of the particular first job request, which can help in identifying and organizing the particular first job request within the cluster(s). The spec field can outline desired behavior of the particular job, including the container image to use, commands to execute, resource requirements, and/or restart policies. The status field can provide real-time information about the execution state of the job (i.e., job status), such as the number of active pods, completion states, and/or any failure conditions.

The interface 120 may receive these first job request(s) and the translator logic 122 may translate them into one or more second job request(s). These second job request(s) may be interpretable by the HPC scheduler 132 while the first job request(s) are not interpretable by the HPC scheduler 132. One typical resource management tool used with HPC clusters is Slurm®. In Slurm®, job requests are typically submitted using job scripts that contain directives and commands defining the parameters and execution details of the job. Similar to the metadata field described above, Slurm® uses directives like #SBATCH--job-name to assign a name to the job, aiding in identification and management. Resource specifications in Slurm® such as #SBATCH--ntasks and/or #SBATCH--cpus-per-task may define the resources allocated for the job similar to the spec field described above. Slurm® may provide mechanism(s) to track the status of jobs, such as squeue or sacct. These may be used to query the current state of jobs within the HPC cluster 130 and provide information similar to the status field described above. This can include whether the job is pending, running, completed, or failed. While Slurm® may not have an equivalent directive to the kind field described above, this may be implied by the context in which the HPC scheduler 132 submits the script.

In embodiments where the control plane 110 is a KCP and the HPC scheduler 132 is Slurm®, the translator logic 122 may translate from a Kubernetes® API Job to a Slurm® job submission. The translator logic 122 may also support translating Slurm® job statuses into Kubernetes® job statuses. Below is an example file in a data serialization language (e.g, yet another markup language (YAML), or YAML ain't markup language) that may be used by the interface 120 to deploy jobs to Slurm® (here, HPC scheduler 132):

```
apiVersion: kfoundry.io/v1alpha1
kind: Job
metadata:
  generateName: k-foundry-example
  namespace: default
spec:
  template:
    spec:
      containers:
      - name:pi
        image: perl:5.34.0
        command: [“perl”, “-Mbignum=bpi”,“-wle”, “printbpi(2000)”]
        resources:
          limits:
            cpu: “4”
            memory: “16Gi”
            nvidia.com/gpu: “1”
          requests:
            cpu: “4”
            memory: “16Gi”
            nvidia.com/gpu: “1”
      restartPolicy: Never
status: { }
```

The communication layer 124 may include interfaces to the control plane 110 and the HPC cluster 130. The communication layer 124 may include one or more features that help facilitate efficient, reliable, and secure data exchange between the control plane 110 and the HPC cluster 130. For example, the communication layer 124 may support protocol compatibility with APIs related to the cloud-native orchestration environment. The communication layer 124 may support low-latency communication to reduce time of transmission between the control plane 110 and the HPC cluster 130. The communication layer 124 may include robust error-handling and retry mechanisms to manage intermittent network issues and help ensure that job requests, job statuses, and other data passed between the control plane 110 and the HPC cluster 130 are accurately and reliably delivered. The communication layer 124 may also include security features like encryption and authentication to protect sensitive job data and prevent unauthorized access.

The communication layer 124 may also support interacting with the HPC scheduler 132 through command-line interfaces (CLI) or remote procedure calls (RPCs). In embodiments where the HPC scheduler 132 is a Slurm®, the communication layer 124 may support commands such as sbatch, squeue, and/or sacct for job submission, status querying, and/or monitoring.

In some embodiments, the interface 120 may allow the HPC cluster 130 to be exposed to features or functions of the cloud-native container orchestration platform that the HPC cluster 130 would otherwise not have access to. For example, the HPC scheduler 132 may not natively support constructs commonly found in cloud-native container orchestration environments, such as nodes, secrets, and configuration maps. Nodes are the worker machines, either virtual or physical, that run the workloads in a cloud-native container orchestration environment. Nodes can host pods (the smallest deployable units) and are managed by the control plane 110 to maintain the desired state of the cluster. By implementing the interface 120 between the control plane 110 and the HPC cluster 130, the HPC cluster 130 may appear to the control plane 110 as one or more nodes within the cloud-native orchestration environment. In other words, by implementing the interface 120 between the control plane 110 and the HPC cluster 130, nodes of the HPC cluster 130 may appear to the control plane 110 as nodes within the cloud-native orchestration environment. For example, in some embodiments, nodes of the HPC cluster 130 may appear to the control plane 110 as nodes under Kubernetes® nodes API resource definition. The control plane 110 may have access to information about each of the nodes of the HPC cluster, such as CPU capacity, GPU capacity, allocable resources, ephemeral storage, node condition and/or health status, workload statuses corresponding to the node, or the like. The control plane 110 may provide or assign tasks to nodes of the HPC cluster 130 in a same or similar manner as the control plane 110 assigns tasks to nodes of the non-HPC cluster 140. For example, the control plane 110 may assign a job to some or all of the nodes via the distributed key-value store 116, which the interface 120 may monitor.

Secrets are objects used to store sensitive information such as passwords, tokens, or keys securely within the orchestration environment. Secrets can enable confidential data to be supplied to containers without exposing it in application code or configuration files. By managing secrets separately, the control plane 110 can enhance security by controlling access and reducing the risk of unauthorized disclosure. By implementing the interface 120 between the control plane 110 and HPC cluster 130, the control plane 110 can share workloads or jobs with secrets with the interface 120, which can handle the secrets in a fashion similar to non-HPC nodes or clusters. For example, if the job request requires retrieving sensitive information for executing tasks, or if the job requires access to a secure database, external API, or private repository, the interface 120 can store and manage credentials corresponding to the secret and provide the needed data to the HPC cluster 130.

Configuration maps are key-value stores (e.g., the distributed key-value store 116, etcd) used to decouple configuration data from container images, allowing applications to be easily reconfigured without rebuilding the images. Configuration maps provide a way to inject configuration settings into pods and containers at runtime, promoting flexibility and consistency across different environments. By implementing the interface 120 between the control plane 110 and HPC cluster 130, the interface 120 can handle these injected configuration settings at runtime and pass along the injected configuration settings to the HPC cluster 130.

According to embodiments, the interface 120 may continuously monitor the distributed key-value store 116 for new entries. The interface 120 may determine that jobs are to be performed by the HPC cluster 130 based on monitoring new entries into the distributed key-value store 116.

According to embodiments, the HPC cluster 130 can represent a high-performance computing environment designed to execute complex computational tasks efficiently and effectively. The cluster includes an HPC scheduler 132 and compute node daemons 134, which collaborate to manage resources and execute workloads across multiple compute nodes within the cluster.

The HPC scheduler 132 may be responsible for orchestrating the allocation of computational tasks to the compute nodes. The HPC scheduler 132 may manage job queues, schedule tasks based on resource availability, job priorities, and predefined policies, and/or optimize the overall utilization of resources of the HPC cluster 130 (i.e., the compute node daemons 134). The HPC scheduler 132 may help ensure that workloads are distributed in a manner that maximizes performance and minimizes execution time. In some embodiments, the HPC scheduler 132 may be implemented using scheduling systems such as Slurm®, Torque®, PBS Pro®, or other industry-standard schedulers. These systems can provide features like job dependency handling, advanced reservation capabilities, and support for heterogeneous computing resources, which can enable the HPC cluster 130 to accommodate a wide range of computational workloads. While aspects and embodiments described herein primarily refer to the HPC scheduler 132 being implemented using Slurm®, any scheduler suitable for use with HPC clusters may be compatible with the present disclosure.

The compute node daemons 134 may be software processes running on each compute node within the HPC cluster 130. These compute node daemons 134 may be responsible for the local management of tasks assigned to their respective nodes. The compute node daemons 134 may communicate with the HPC scheduler 132 to receive job assignments, report on the status of running tasks, and provide updates on resource utilization such as CPU load, memory usage, and I/O statistics. The compute node daemons 134 can facilitate the initiation and termination of computational tasks, handle local scheduling nuances, and manage inter-process communication required for parallel processing tasks.

In some embodiments, the integration of the HPC scheduler 132 with the compute node daemons 134 can enable the HPC cluster 130 to function as a cohesive system capable of handling demanding computational tasks. The HPC scheduler 132 may have a global view of the cluster's resources, which may allow the HPC scheduler 132 to make informed decisions about task placement and resource allocation. The compute node daemons 134 may provide the execution environment and monitoring at the node level. This design may support scalability, allowing the cluster to expand by adding more compute nodes without significant changes to the management framework.

In some embodiments, the HPC scheduler 132 may provide information about the resources, state, and activity of the HPC cluster 130 to the interface 120. At least some of this information may then be conveyed to the control plane 110 so that the control plane 110 may efficiently schedule jobs among the clusters (or nodes) of the system 100. This information may include node information, user and job queue information, scheduler state and policy information, resource utilization and monitoring information, configuration and environmental information, and/or power and energy management information.

The node information may include the number of CPUs, available memory, GPUs, network interfaces, and other hardware characteristics. It may also include the current state of each compute node daemon 134 (e.g., idle, allocated, drained, or down) and resource usage.

The user and job queue information may include data on pending, running, and completed/failed jobs. It may also include information about the priority, submission time, required resources (such as CPUs, memory, GPUs, or number of compute node daemons 134), job dependencies, expected runtime, and/or any specified constraints or preferences of the job.

The scheduler state and policy information may include the current configuration and policies of the HPC scheduler 132 or the compute node daemons 134, which may correspond to how jobs are prioritized or how resources of the HPC cluster 130 are allocated. This information may include scheduling algorithms, resource allocation policies (e.g., fair-share or priority-based), and job placement strategies.

The resource utilization and monitoring information may include real-time data on resource usage across the HPC cluster 130, such as CPU load, memory utilization, and input/output (I/O) statistics for both compute node daemons 134 and individual jobs. This information may be used to identify resource availability or to identify potential bottlenecks.

The configuration and environmental information may include configuration and environmental variables that govern the overall setup of the HPC cluster 130, including networking parameters, job submission limits, and/or runtime environment settings (like compiler and library paths). This configuration data can help ensure that jobs are executed with the appropriate environment and helps enforce uniform conditions across the cluster.

The power and energy management data may include power usage statistics across the compute node daemons 134, which may be used to optimize energy consumption. This information may also include temperature information (e.g., if resources are first allocated to CPUs or GPUs with lower temperatures).

According to embodiments, implementing the interface 120 between the control plane 110 and the HPC cluster 130 allows for dynamic modification of jobs during HPC runtime. Conventionally, while an HPC cluster is performing a job, the workload of the job cannot dynamically grow or shrink. In essence, once an HPC cluster initiates a job, the job either succeeds or fails as it was initialized. However, by implementing the interface 120 between the HPC cluster 130 and the control plane 110, in at least some cases, the HPC cluster may communicate with the control plane 110 (via the interface 120) and query itself. For example, if not enough CPUs or compute node daemons 134 are assigned to a job being performed by the HPC cluster 130, the HPC cluster 130 may indicate such via job statuses (e.g., “pending” job status or “insufficient memory/CPU” job status). The control plane 110 may update the job request by allocating more CPUs or compute node daemons 134, which update may then be sent to the HPC cluster 130 (via the interface 120). Other reasons for dynamic changes during the runtime of a job may be to perform a replica job, error handling, data preprocessing and/or augmentation, data sharding and distribution, or the like. Another reason for dynamic changes during the runtime may be based on sequential tasks to be performed by the HPC cluster 130. A first task of a job may require a smaller amount of resources, while a second task of the job may require a significantly larger amount of resources. Dynamically allocating less resources while the HPC cluster 130 performs the first task and more resources while the HPC cluster 130 performs the second task allows for a more efficient use of HPC cluster 130 resources.

In some embodiments, the job being performed by the HPC cluster 130 may request a parallel process to be deployed on its behalf. This parallel process may be a child thread or process of the job. This child thread/process may not be threaded on a same kernel process as the job, but could be threaded in a compute node daemon 134 next to the kernel process of the job. This may be performed by relaying the request for the child process to the control plane 110 via the interface 120. For example, this request for the child process may include identifying the job (e.g., the job number) and the child process to be implemented. The control plane 110 may add a workload associated with the child process to the workload of the job. Then, the control plane 110 may update the distributed key-value store 116 with the updated job (i.e., job and child process). The interface 120 may read the new entry into the distributed key-value store 116 and cause the HPC cluster 130 to execute both the job and the new child process.

The system 100 may also include one or more non-HPC clusters 140. These non-HPC clusters 140 may be clusters of resources within the cloud-native container orchestration platform. In at least some embodiments, these non-HPC clusters 140 may be Kubernetes® clusters.

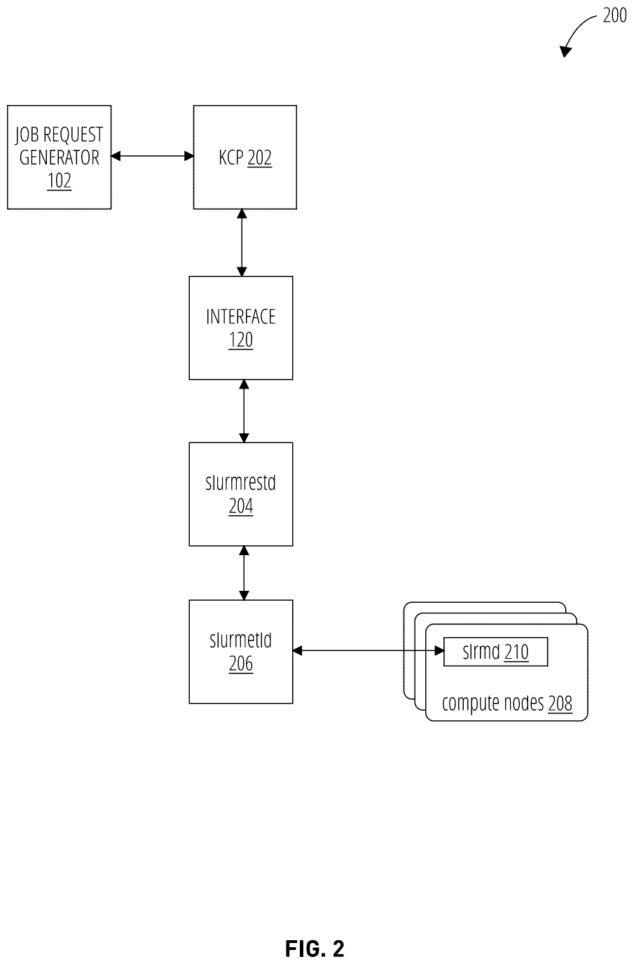

FIG. 2 illustrates a system 200 including a Kubernetes® control plane (KCP) 202 and a Slurm® resource manager slurmrestd 204, according to one embodiment. In some embodiments, the slurmrestd 204 is a representational state transfer (REST) API server for Slurm® that provides a web-based interface to interact with Slurm workload manager functionalities. The system 200 may be an exemplary embodiment of system 100. As such, the system 200 may include some or all of the features of system 100 as described herein. The KCP 202 may include some or all of the features described herein with respect to the control plane 110. The control plane 110 may include some or all of the features of a KCP. The slurmrestd 204 may include some or all of the features described herein with respect to the HPC cluster 130. The HPC cluster 130 may include some or all of the features of a Slurm® resource manager.

As illustrated, the KCP 202 may receive job requests from the job request generator 102. The KCP 202 may communicate job requests to the slurmrestd 204 via the interface 120. As described herein, the interface 120 may translate data communicated to and from the KCP 202 and slurmrestd 204 via the translator logic 122. The slurmrestd 204 may communicate with a Slurm® clastic tree load daemon (slurmetld) 206, which is a component designed to help manage elastic computing resources, such as dynamically adding or removing nodes from a cluster based on workload demands. The workload associated with job requests received by the slurmrestd 204 may be performed by the compute nodes 208. These compute nodes 208 may be virtual compute nodes or physical compute nodes.

The following description is an example workload deployment within the system 200. This workload deployment is meant to be illustrative and merely exemplary. First, the job request generator 102 may send one or more job requests to the KCP 202. The KCP 202 may include a Kube API server which stores the payload into the distributed key-value store 116 (etcd). Once the payload is in the distributed key-value store 116, the interface 120 may detect that there is a new entry into the database, gather the payload, and deconstruct the payload. Upon deconstructing the payload, the interface 120 may determine that the HPC cluster 130 is to perform a computationally-intensive job. The interface 120 may then translate (via the translator logic 122) the payload into interpretable command line(s) for the slurmrestd 204. Then, the interface 120 may generate a watch share job as a GO thread (i.e., a thread in the Go programming language, or a watch share job in any other suitable programming language). The watch share job may be used to monitor the status of the job(s) are they are performed by the compute nodes 208. The interface 120 will expose some or all of the information about the state of these job(s) into the distributed key-value store 116.

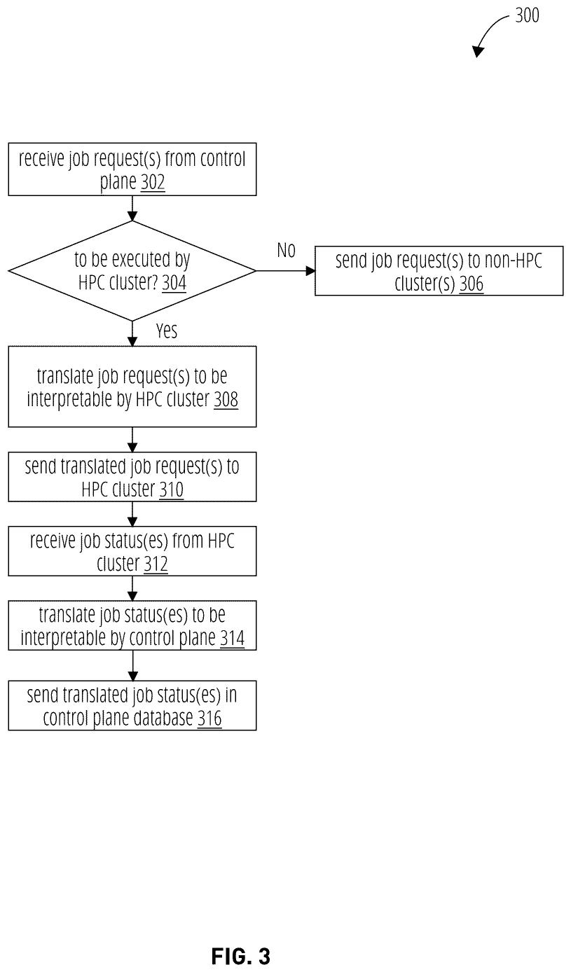

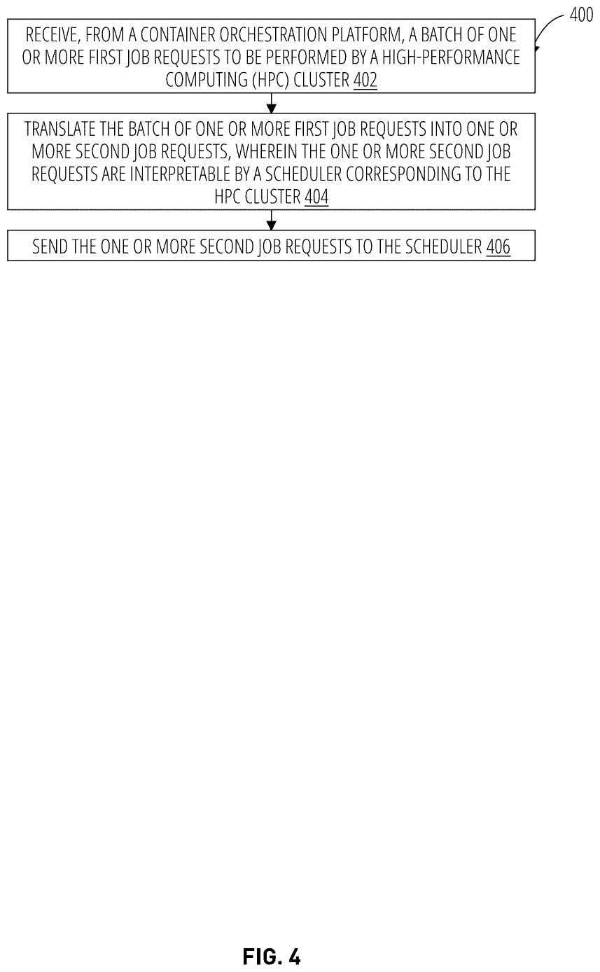

FIG. 3 is a flow diagram of an example method 300 for operating an HPC cluster within a cloud-native container orchestration environment, according to at least one embodiment. FIG. 4 is a flow diagram of an example method 400 for translating data between a cloud-native, according to at least one embodiment.

Methods 300 and/or 400 can be performed using one or more processing units (e.g., CPUs, GPUs, accelerators, physics processing units (PPUs), data processing units (DPUs), etc.), which may include (or communicate with) one or more memory devices. In at least one embodiment, methods 300 and/or 400 can be performed using a processing device or processing devices. According to embodiments, methods 300 and/or 400 can be performed by one or more processing devices (also referred to as processing units) executing instructions stored in memory. In at least one embodiment, methods 300 and/or 400 can be performed using processing units of component of FIG. 1. In at least one embodiment, methods 300 and/or 400 can be performed by the interface 120 of FIG. 1 and/or other components of the system 100 of FIG. 1. In at least one embodiment, processing units performing any of methods 300 and/or 400 can be executing instructions stored on a non-transient computer readable storage media. In at least one embodiment, any of methods 300 and/or 400 can be performed using multiple processing threads (e.g., CPU threads and/or GPU threads), individual threads executing one or more individual functions, routines, subroutines, or operations of the method. In at least one embodiment, processing threads implementing any of methods 300 and/or 400 can be synchronized (e.g., using semaphores, critical sections, and/or other thread synchronization mechanisms). Alternatively, processing threads implementing any of methods 300 and/or 400 can be executed asynchronously with respect to each other. Various operations of methods 300 and/or 400 can be performed in a different order compared with the order shown in FIG. 3 and/or FIG. 4. Some operations of any of methods 300 and/or 400 can be performed concurrently with other operations. In at least one embodiment, one or more operations shown in FIG. 3 and/or FIG. 4 may not always be performed.

FIG. 3 is a flow diagram of an example method 300 for operating an HPC cluster within a cloud-native container orchestration environment, according to at least one embodiment. At block 302, processing units executing method 300 can receive one or more job requests from a control plane. In at least one embodiment, the processing units may receive the one or more job request by monitoring a key-value store, such as the distributed key-value store 116.

At decision block 304, the processing units executing method 300 can determine whether the job request(s) are to be executed by an HPC cluster, such as the HPC cluster 130. If a new entry indicates that a corresponding job request is to be performed by an HPC cluster, the processing units may determine that the job request has been received from a control plane. The control plane may be within a cloud-native container orchestration environment, such as Kubernetes®. In at least one embodiment, job requests to be performed by an HPC cluster may have a corresponding annotation.

At block 306, if the job request is not to be performed by an HPC cluster, the processing units executing method 300 may cause a non-HPC cluster to execute or otherwise complete the job requests.

At block 308, processing units executing method 300 may translate the job requests such that they are interpretable by a scheduler or workload manager that schedules jobs and/or allocates resources for the HPC cluster 130. In at least one embodiment, this scheduler or workload manager may be a Slurm®. According to embodiments, this translation may be performed as described herein with respect to the translator logic 122.

At block 310, processing units executing method 300 can send the translated job requests to the HPC cluster, or to the HPC scheduler/workload manager. The HPC scheduler/workload manager may initiate one or more workloads corresponding to the job requests based on the translated job requests.

At block 312, processing units executing method 300 can receive one or more job statuses from the HPC cluster. These job statuses may each correspond to a job request.

At block 314, processing units executing method 300 can translate these job statuses to be interpretable by the control plane that sent the job requests. In other words, processing units executing method 300 can translate these job statuses to be interpretable within the cloud-native container orchestration environment.

At block 316, processing units executing method 300 can send the translated job statuses to a control plane database. This database may be the key-value store. The control plane may have access to the key-value store and monitor these job statuses.

FIG. 4 is a flow diagram of an example method 400 for translating data between a cloud-native container orchestration platform, such as a control plane, and an HPC cluster, according to at least one embodiment. At block 402, processing units executing method 400 can receive a batch of one or more first job requests to be performed by a high-performance computing (HPC) cluster. This batch of one or more first job requests may be received from a container orchestration platform. This batch of one or more first job requests may be received by monitoring a database (e.g., distributed key-value store 116) for new entries, and determining that one or more of these new entries are job requests to be performed by an HPC cluster. According to embodiments, these first job requests may correspond to operations associated with training an artificial intelligence (AI) model.

At block 404, processing units executing method 400 can translate the batch of one or more first job requests into one or more second job requests. These one or more second job requests may be interpretable by a scheduler corresponding to the HPC cluster. In at least some embodiments, the one or more second job requests may be generated based on a topology of the HPC cluster. For example, the first job requests may each include a required (or target) amount of resources (i.e., CPUs, GPUs, control node daemons). This required amount of resources may be included in the corresponding second job requests. This information may be used to request certain compute nodes or adjust a size of a control node daemon for the second job request.

At block 406, processing units executing method 400 can send the one or more second job requests to the scheduler.

According to embodiments, the processing units executing method 400 may determine one or more second job statuses corresponding to the one or more second job requests. For example, the processing units may monitor the HPC cluster and periodically ask the HPC cluster to provide an update as to the status of the job. In other embodiments, the HPC cluster may automatically provide these job status updates. The processing units executing method 400 may translate these second job statuses into one or more first job statuses corresponding to the one or more first job requests. The processing units executing method 400 may send the one or more first job statuses to the key-value store (or other suitable database) maintained by a container orchestration platform that is configured to orchestrated containerized workloads, such as a control panel. The control plane may then read the key value store and determine the state of operations in the HPC cluster based on the first job statuses.

In some embodiments, processing units executing method 400 may detect an event associated with execution of the one or more second job requests within the HPC cluster. For example, as described above, the control plane may monitor the key value store for updates in the status of the first job requests. This event may be any relevant status of the job (e.g., pending, active, failed, success, or the like). The processing units executing method 400 may update a state (e.g., job status) of one or more custom resources (CRs) allocated by the container orchestration platform for the one or more first job requests that map to the one or more second job requests. For example, the state may be updated in a key value store in embodiments. The updated state may provide notification to the container orchestration platform.

One task to which HPCs are well suited is training of artificial intelligence (AI) models, such as neural networks, large language models (LLMs), generative models, and so on. Embodiments enable the training of AI models to be managed in an environment such as Kubernetes®, and to be executed in an HPC environment such as Slurm®.

### Inference and Training Logic

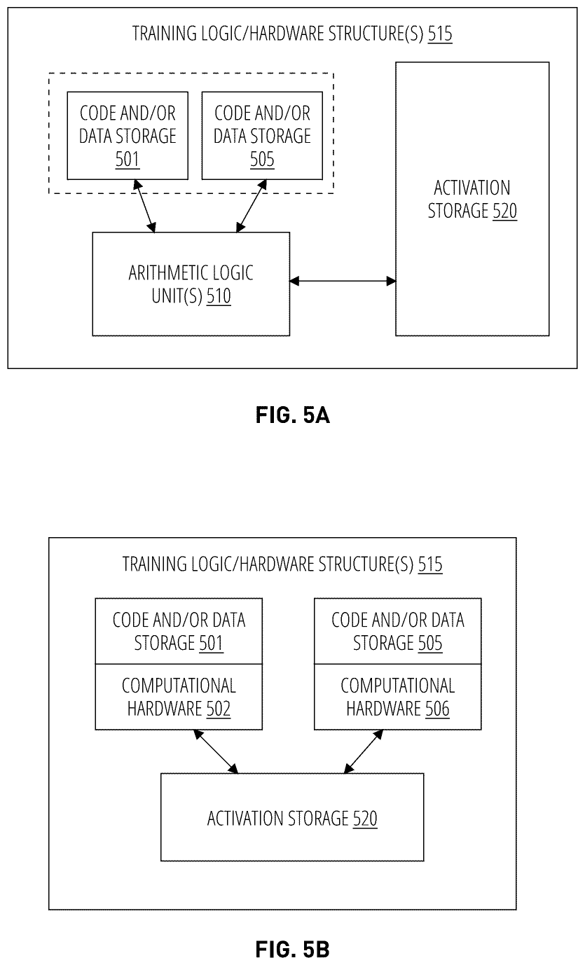

FIG. 5A illustrates inference and/or training logic 515 used to perform inferencing and/or training operations associated with one or more embodiments. FIGS. 5A-7 illustrate different jobs or tasks that may be performed by an HPC cluster based on job requests generated by a control plane within a cloud-native container orchestration environment, such as Kubernetes®.

In at least one embodiment, inference and/or training logic 515 may include, without limitation, code and/or data storage 501 to store forward and/or output weight and/or input/output data, and/or other parameters to configure neurons or layers of a neural network trained and/or used for inferencing in aspects of one or more embodiments. In at least one embodiment, training logic 515 may include (or be coupled to code and/or data storage 501 that stores) graph code or other software to control timing and/or order, in which weight and/or other parameter information is to be loaded to configure processing units, including logic units, integer and/or floating point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 501 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 501 may be included with other on-chip or off-chip data storage, including a processor's L1, L2, or L3 cache or system memory.

In at least one embodiment, any portion of code and/or data storage 501 may be internal or external to one or more processors or other hardware logic devices or circuits. In at least one embodiment, code and/or data storage 501 may be cache memory, dynamic randomly addressable memory (“DRAM”), static randomly addressable memory (“SRAM”), non-volatile memory (e.g., flash memory), or other storage. In at least one embodiment, a choice of whether code and/or data storage 501 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 515 may include, without limitation, a code and/or data storage 505 to store backward and/or output weight and/or input/output data corresponding to neurons or layers of a neural network trained and/or used for inferencing in aspects of one or more embodiments. In at least one embodiment, code and/or data storage 505 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 515 may include (or be coupled to code and/or data storage 505 that stores) graph code or other software to control timing and/or order, in which weight and/or other parameter information is to be loaded to configure processing units, including logic units, integer and/or floating point units (collectively, arithmetic logic units (ALUs)).

In at least one embodiment, code, such as graph code, causes the loading of weight or other parameter information into processor ALUs based on an architecture of a neural network to which such code corresponds. In at least one embodiment, any portion of code and/or data storage 505 may be included with other on-chip or off-chip data storage, including a processor's L1, L2, or L3 cache or system memory. In at least one embodiment, any portion of code and/or data storage 505 may be internal or external to one or more processors or other hardware logic devices or circuits. In at least one embodiment, code and/or data storage 505 may be cache memory, DRAM, SRAM, non-volatile memory (e.g., flash memory), or other storage. In at least one embodiment, a choice of whether code and/or data storage 505 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or code and/or data storage 501 and code and/or data storage 505 may be separate storage structures. In at least one embodiment, code and/or data storage 501 and code and/or data storage 505 may be a combined storage structure. In at least one embodiment, code and/or data storage 501 and code and/or data storage 505 may be partially combined and partially separate. In at least one embodiment, any portion of code and/or data storage 501 and code and/or data storage 505 may be included with other on-chip or off-chip data storage, including a processor's L1, L2, or L3 cache or system memory.

In at least one embodiment, inference and/or training logic 515 may include, without limitation, one or more arithmetic logic unit(s) (“ALU(s)”) 510, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 520 that are functions of input/output and/or weight parameter data stored in code and/or data storage 501 and/or code and/or data storage 505. In at least one embodiment, activations stored in activation storage 520 are generated according to linear algebraic and/or matrix-based mathematics performed by ALU(s) 510 in response to performing instructions or other code, wherein weight values stored in code and/or data storage 505 and/or code and/or data storage 501 are used as operands along with other values, such as bias values, gradient information, momentum values, or other parameters or hyperparameters, any or all of which may be stored in code and/or data storage 505 or code and/or code and/or data storage 501 or another storage on or off-chip.

In at least one embodiment, ALU(s) 510 are included within one or more processors or other hardware logic devices or circuits, whereas in another embodiment, ALU(s) 510 may be external to a processor or other hardware logic device or circuit that uses them (e.g., a co-processor). In at least one embodiment, ALU(s) 510 may be included within a processor's execution units or otherwise within a bank of ALUs accessible by a processor's execution units either within the same processor or distributed between different processors of different types (e.g., central processing units, graphics processing units, fixed function units, etc.). In at least one embodiment, code and/or data storage 501, code and/or data storage 505, and activation storage 520 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 520 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 520 may be cache memory, DRAM, SRAM, non-volatile memory (e.g., flash memory), or other storage. In at least one embodiment, activation storage 520 may be completely or partially within or external to one or more processors or other logical circuits. In at least one embodiment, a choice of whether activation storage 520 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 515 illustrated in FIG. 5A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5A may be used in conjunction with central processing unit (“CPU”) hardware, graphics processing unit (“GPU”) hardware or other hardware, such as field programmable gate arrays (“FPGAs”).

FIG. 5B illustrates inference and/or training logic 515, according to at least one embodiment. In at least one embodiment, inference and/or training logic 515 may include, without limitation, hardware logic in which computational resources are dedicated or otherwise exclusively used in conjunction with weight values or other information corresponding to one or more layers of neurons within a neural network. In at least one embodiment, inference and/or training logic 515 illustrated in FIG. 5B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5B may be used in conjunction with central processing unit (CPU) hardware, graphics processing unit (GPU) hardware or other hardware, such as field programmable gate arrays (FPGAs). In at least one embodiment, inference and/or training logic 515 includes, without limitation, code and/or data storage 501 and code and/or data storage 505, which may be used to store code (e.g., graph code), weight values and/or other information, including bias values, gradient information, momentum values, and/or other parameter or hyperparameter information. In at least one embodiment illustrated in FIG. 5B, each of code and/or data storage 501 and code and/or data storage 505 is associated with a dedicated computational resource, such as computational hardware 502 and computational hardware 506, respectively. In at least one embodiment, each of computational hardware 502 and computational hardware 506 comprises one or more ALUs that perform mathematical functions, such as linear algebraic functions, only on information stored in code and/or data storage 501 and code and/or data storage 505, respectively, the result of which is stored in activation storage 520.

In at least one embodiment, each of code and/or data storage 501 and 505 and corresponding computational hardware 502 and 506, respectively, correspond to different layers of a neural network, such that resulting activation from one storage/computational pair 501/502 of code and/or data storage 501 and computational hardware 502 is provided as an input to a next storage/computational pair 505/506 of code and/or data storage 505 and computational hardware 506, in order to mirror a conceptual organization of a neural network. In at least one embodiment, each of storage/computational pairs 501/502 and 505/506 may correspond to more than one neural network layer. In at least one embodiment, additional storage/computation pairs (not shown) subsequent to or in parallel with storage/computation pairs 501/502 and 505/506 may be included in inference and/or training logic 515.

### Neural Network Training and Deployment

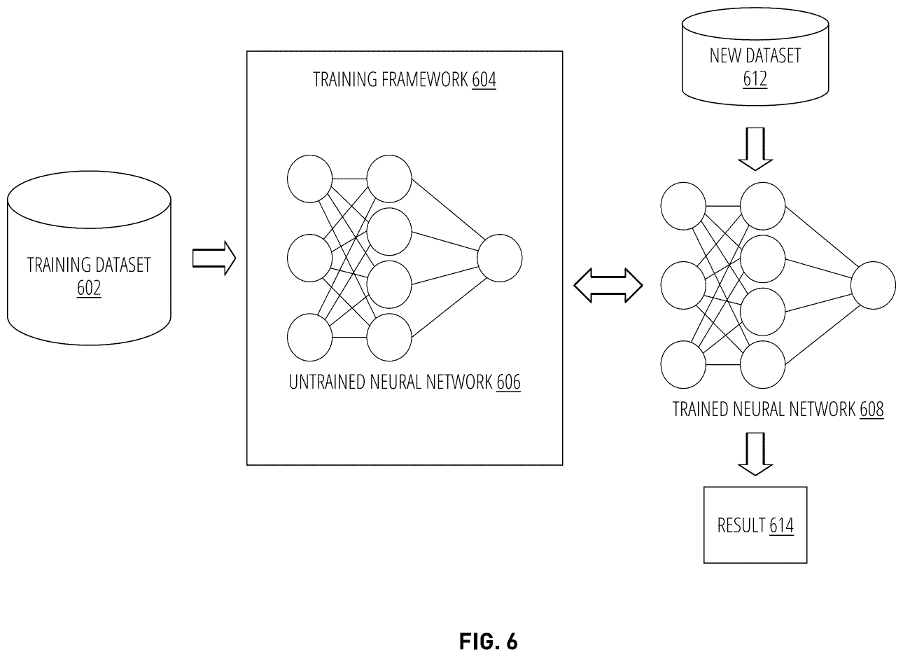

FIG. 6 illustrates training and deployment of a deep neural network, according to at least one embodiment. In at least one embodiment, untrained neural network 606 is trained using a training dataset 602. In at least one embodiment, training framework 604 is a PyTorch framework, whereas in other embodiments, training framework 604 is a TensorFlow, Boost, Caffe, Microsoft Cognitive Toolkit/CNTK, MXNet, Chainer, Keras, Deeplearning4j, or other training framework. In at least one embodiment, training framework 604 trains an untrained neural network 606 and enables it to be trained using processing resources described herein to generate a trained neural network 608. In at least one embodiment, weights may be chosen randomly or by pre-training using a deep belief network. In at least one embodiment, training may be performed in either a supervised, partially supervised, or unsupervised manner.

In at least one embodiment, untrained neural network 606 is trained using supervised learning, wherein training dataset 602 includes an input paired with a desired output for an input, or where training dataset 602 includes input having a known output and an output of neural network 606 is manually graded. In at least one embodiment, untrained neural network 606 is trained in a supervised manner and processes inputs from training dataset 602 and compares resulting outputs against a set of expected or desired outputs. In at least one embodiment, errors are then propagated back through untrained neural network 606. In at least one embodiment, training framework 604 adjusts weights that control untrained neural network 606. In at least one embodiment, training framework 604 includes tools to monitor how well untrained neural network 606 is converging towards a model, such as trained neural network 608, suitable to generating correct answers, such as in result 614, based on input data such as a new dataset 612. In at least one embodiment, training framework 604 trains untrained neural network 606 repeatedly while adjusting weights to refine an output of untrained neural network 606 using a loss function and adjustment algorithm, such as stochastic gradient descent. In at least one embodiment, training framework 604 trains untrained neural network 606 until untrained neural network 606 achieves a desired accuracy. In at least one embodiment, trained neural network 608 can then be deployed to implement any number of machine learning operations.

In at least one embodiment, untrained neural network 606 is trained using unsupervised learning, wherein untrained neural network 606 attempts to train itself using unlabeled data. In at least one embodiment, unsupervised learning training dataset 602 will include input data without any associated output data or “ground truth” data. In at least one embodiment, untrained neural network 606 can learn groupings within training dataset 602 and can determine how individual inputs are related to untrained dataset 602. In at least one embodiment, unsupervised training can be used to generate a self-organizing map in trained neural network 608 capable of performing operations useful in reducing dimensionality of new dataset 612. In at least one embodiment, unsupervised training can also be used to perform anomaly detection, which allows identification of data points in new dataset 612 that deviate from normal patterns of new dataset 612.

In at least one embodiment, semi-supervised learning may be used, which is a technique in which training dataset 602 includes a mix of labeled and unlabeled data. In at least one embodiment, training framework 604 may be used to perform incremental learning, such as through transferred learning techniques. In at least one embodiment, incremental learning enables trained neural network 608 to adapt to new dataset 612 without forgetting knowledge instilled within trained neural network 608 during initial training.

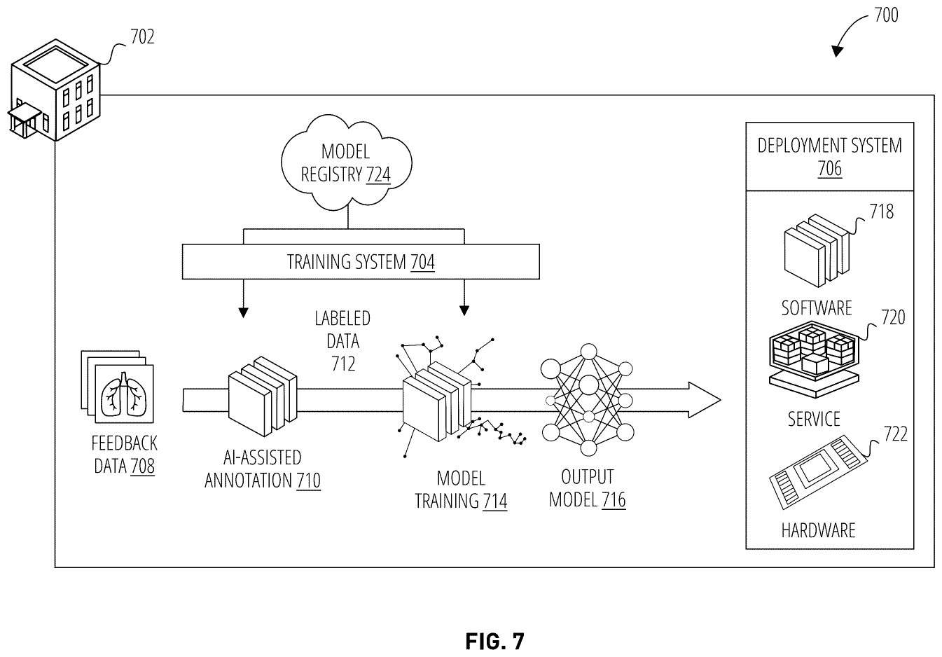

With reference to FIG. 7, FIG. 7 is an example data flow diagram for a process 700 of generating and deploying a processing and inferencing pipeline, according to at least one embodiment. In at least one embodiment, process 700 may be deployed to perform game name recognition analysis and inferencing on user feedback data at one or more facilities 702, such as a data center.

In at least one embodiment, process 700 may be executed within a training system 704 and/or a deployment system 706. In at least one embodiment, training system 704 may be used to perform training, deployment, and embodiment of machine learning models (e.g., neural networks, object detection algorithms, computer vision algorithms, etc.) for use in deployment system 706. In at least one embodiment, deployment system 706 may be configured to offload processing and compute resources among a distributed computing environment to reduce infrastructure requirements at facility 702. In at least one embodiment, deployment system 706 may provide a streamlined platform for selecting, customizing, and implementing virtual instruments for use with computing devices at facility 702. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 706 during execution of applications.

In at least one embodiment, some applications used in advanced processing and inferencing pipelines may use machine learning models or other AI to perform one or more processing steps. In at least one embodiment, machine learning models may be trained at facility 702 using feedback data 708 (such as imaging data) stored at facility 702 or feedback data 708 from another facility or facilities, or a combination thereof. In at least one embodiment, training system 704 may be used to provide applications, services, and/or other resources for generating working, deployable machine learning models for deployment system 706.

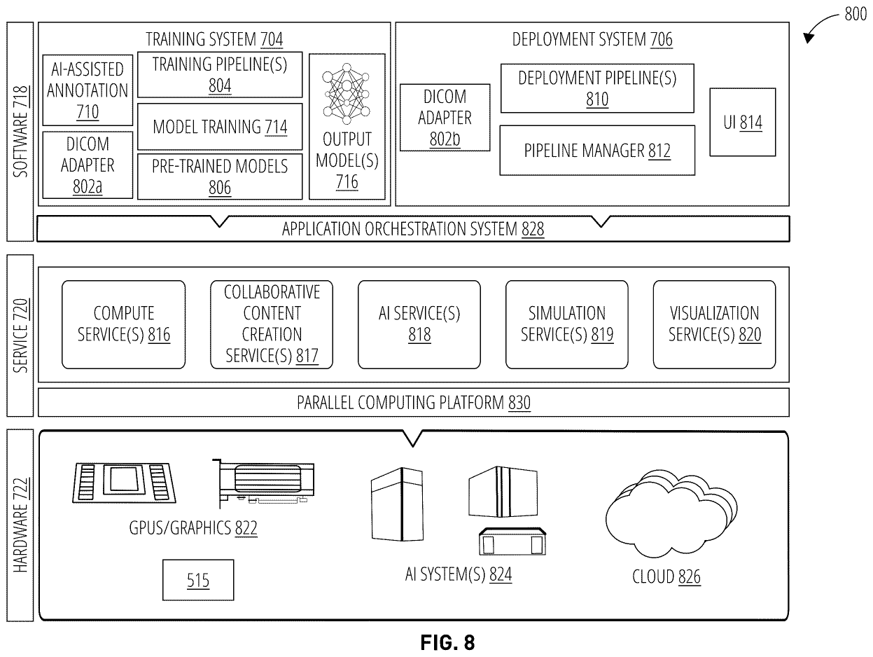

In at least one embodiment, a model registry 724 may be backed by object storage that may support versioning and object metadata. In at least one embodiment, object storage may be accessible through, for example, a cloud storage (e.g., a cloud 826 of FIG. 8) compatible application programming interface (API) from within a cloud platform. In at least one embodiment, machine learning models within model registry 724 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline(s) 804 (FIG. 8) may include a scenario where facility 702 is training their own machine learning model or has an existing machine learning model that needs to be optimized or updated. In at least one embodiment, feedback data 708 may be received from various channels, such as forums, web forms, or the like. In at least one embodiment, once feedback data 708 is received, AI-assisted annotation 710 may be used to aid in generating annotations corresponding to feedback data 708 to be used as ground truth data for a machine learning model. In at least one embodiment, AI-assisted annotation 710 may include one or more machine learning models (e.g., convolutional neural networks (CNNs)) that may be trained to generate annotations corresponding to certain types of feedback data 708 (e.g., from certain devices) and/or certain types of anomalies in feedback data 708. In at least one embodiment, AI-assisted annotations 710 may then be used directly, or may be adjusted or fine-tuned using an annotation tool, to generate ground truth data. In at least one embodiment, in some examples, labeled data 712 may be used as ground truth data for training a machine learning model. In at least one embodiment, AI-assisted annotations 710, labeled data 712, or a combination thereof may be used as ground truth data for training a machine learning model, e.g., via model training 714 in FIG. 7 and/or FIG. 8. In at least one embodiment, a trained machine learning model may be referred to as an output model 716, and may be used by deployment system 706, as described herein.

In at least one embodiment, training pipeline(s) 804 (FIG. 8) may include a scenario where facility 702 needs a machine learning model for use in performing one or more processing tasks for one or more applications in deployment system 706, but facility 702 may not currently have such a machine learning model (or may not have a model that is optimized, efficient, or effective for such purposes). In at least one embodiment, an existing machine learning model may be selected from model registry 724. In at least one embodiment, model registry 724 may include machine learning models trained to perform a variety of different inference tasks on imaging data. In at least one embodiment, machine learning models in model registry 724 may have been trained on imaging data from different facilities than facility 702 (e.g., facilities that are remotely located). In at least one embodiment, machine learning models may have been trained on imaging data from one location, two locations, or any number of locations. In at least one embodiment, when being trained on imaging data, which may be a form of feedback data 708, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 724. In at least one embodiment, a machine learning model may then be retrained, or updated, at any number of other facilities, and a retrained or updated model may be made available in model registry 724. In at least one embodiment, a machine learning model may then be selected from model registry 724—and referred to as output model(s) 716—and may be used in deployment system 706 to perform one or more processing tasks for one or more applications of a deployment system.

In at least one embodiment, training pipeline(s) 804 (FIG. 8) may be used in a scenario that includes facility 702 requiring a machine learning model for use in performing one or more processing tasks for one or more applications in deployment system 706, but facility 702 may not currently have such a machine learning model (or may not have a model that is optimized, efficient, or effective for such purposes). In at least one embodiment, a machine learning model selected from model registry 724 might not be fine-tuned or optimized for feedback data 708 generated at facility 702 because of differences in populations, genetic variations, robustness of training data used to train a machine learning model, diversity in anomalies of training data, and/or other issues with training data. In at least one embodiment, AI-assisted annotation 710 may be used to aid in generating annotations corresponding to feedback data 708 to be used as ground truth data for retraining or updating a machine learning model. In at least one embodiment, labeled data 712 may be used as ground truth data for training a machine learning model. In at least one embodiment, retraining or updating a machine learning model may be referred to as model training 714. In at least one embodiment, model training 714 may include data—e.g., AI-assisted annotations 710, labeled data 712, or a combination thereof—that may be used as ground truth data for retraining or updating a machine learning model.

In at least one embodiment, deployment system 706 may include software 718, service 720, hardware 722, and/or other components, features, and functionality. In at least one embodiment, deployment system 706 may include a software “stack,” such that software 718 may be built on top of service 720 and may use service 720 to perform some or all of processing tasks, and service 720 and software 718 may be built on top of hardware 722 and use hardware 722 to execute processing, storage, and/or other compute tasks of deployment system 706.

In at least one embodiment, software 718 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 708 (or other data types, such as those described herein). In at least one embodiment, an advanced processing and inferencing pipeline may be defined based on selections of different containers that are desired or required for processing feedback data 708, in addition to containers that receive and configure imaging data for use by each container and/or for use by facility 702 after processing through a pipeline (e.g., to convert outputs back to a usable data type for storage and display at facility 702). In at least one embodiment, a combination of containers within software 718 (e.g., that make up a pipeline) may be referred to as a virtual instrument (as described in more detail herein), and a virtual instrument may leverage service 720 and hardware 722 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output model(s) 716 of training system 704.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 724 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 720 as a system (e.g., system 800 of FIG. 8). In at least one embodiment, once validated by system 800 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., system 800 of FIG. 8). In at least one embodiment, completed and validated applications or containers may be stored in a container registry and associated machine learning models may be stored in model registry 724. In at least one embodiment, a requesting entity that provides an inference or image processing request may browse a container registry and/or model registry 724 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 706 (e.g., a cloud) to perform processing of a data processing pipeline. In at least one embodiment, processing by deployment system 706 may include referencing selected elements (e.g., applications, containers, models, etc.) from a container registry and/or model registry 724. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, service 720 may be leveraged. In at least one embodiment, service 720 may include compute services, collaborative content creation services, simulation services, artificial intelligence (AI) services, visualization services, and/or other service types. In at least one embodiment, service 720 may provide functionality that is common to one or more applications in software 718, so functionality may be abstracted to a service that may be called upon or leveraged by applications. In at least one embodiment, functionality provided by service 720 may run dynamically and more efficiently, while also scaling well by allowing applications to process data in parallel, e.g., using a parallel computing platform 830 (FIG. 8). In at least one embodiment, rather than each application that shares a same functionality offered by a service 720 being required to have a respective instance of service 720, service 720 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 720 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more processing operations associated with segmentation tasks. In at least one embodiment, software 718 implementing advanced processing and inferencing pipeline may be streamlined because each application may call upon the same inference service to perform one or more inferencing tasks.

In at least one embodiment, hardware 722 may include GPUs, CPUs, data processing units (DPUs), an AI/deep learning system (e.g., an AI supercomputer, such as NVIDIA's DGX™ supercomputer system), a cloud platform, or a combination thereof. In at least one embodiment, different types of hardware 722 may be used to provide efficient, purpose-built support for software 718 and service 720 in deployment system 706. In at least one embodiment, use of GPU processing may be implemented for processing locally (e.g., at facility 702), within an AI/deep learning system, in a cloud system, and/or in other processing components of deployment system 706 to improve efficiency, accuracy, and efficacy of game name recognition.

In at least one embodiment, software 718 and/or service 720 may be optimized for GPU processing with respect to deep learning, machine learning, and/or high-performance computing, simulation, and visual computing, as non-limiting examples. In at least one embodiment, at least some of the computing environment of deployment system 706 and/or training system 704 may be executed in a datacenter or one or more supercomputers or high performance computing systems, with GPU-optimized software (e.g., hardware and software combination of NVIDIA's DGX™ system). In at least one embodiment, hardware 722 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 8 is a system diagram for an example system 800 for generating and deploying a deployment pipeline, according to at least one embodiment. In at least one embodiment, system 800 may be used to implement process 700 of FIG. 7 and/or other processes including advanced processing and inferencing pipelines. In at least one embodiment, system 800 may include training system 704 and deployment system 706. In at least one embodiment, training system 704 and deployment system 706 may be implemented using software 718, services 720, and/or hardware 722, as described herein. The system 100 described above with respect to FIG. 1 may include one or more of the example system 800.

In at least one embodiment, system 800 (e.g., training system 704 and/or deployment system 706) may implemented in a cloud computing environment (e.g., using cloud 826). In at least one embodiment, system 800 may be implemented locally with respect to a facility, or as a combination of both cloud and local computing resources. In at least one embodiment, access to APIs in cloud 826 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 800, may be restricted to a set of public internet service providers (ISPs) that have been vetted or authorized for interaction.

In at least one embodiment, various components of system 800 may communicate between and among one another using any of a variety of different network types, including but not limited to local area networks (LANs) and/or wide area networks (WANs) via wired and/or wireless communication protocols. In at least one embodiment, communication between facilities and components of system 800 (e.g., for transmitting inference requests, for receiving results of inference requests, etc.) may be communicated over a data bus or data busses, wireless data protocols (e.g., Wi-Fi), wired data protocols (e.g., Ethernet), etc.

In at least one embodiment, training system 704 may execute training pipelines 804, similar to those described herein with respect to FIG. 7. In at least one embodiment, where one or more machine learning models are to be used in deployment pipeline(s) 810 by deployment system 706, training pipeline(s) 804 may be used to train or retrain one or more (e.g., pre-trained) models, and/or implement one or more of pre-trained models 806 (e.g., without a need for retraining or updating). In at least one embodiment, as a result of training pipeline(s) 804, output model(s) 716 may be generated. In at least one embodiment, training pipeline(s) 804 may include any number of processing steps, AI-assisted annotation 710, labeling or annotating of feedback data 708 to generate labeled data 712, model selection from a model registry, model training 714, training, retraining, or updating models, and/or other processing steps. In at least one embodiment, DICOM adapter 802a can be used to access DICOM data. In at least one embodiment, for different machine learning models used by deployment system 706, different training pipeline(s) 804 may be used. In at least one embodiment, training pipeline(s) 804, similar to a first example described with respect to FIG. 7, may be used for a first machine learning model, training pipeline(s) 804, similar to a second example described with respect to FIG. 7, may be used for a second machine learning model, and training pipeline(s) 804, similar to a third example described with respect to FIG. 7, may be used for a third machine learning model. In at least one embodiment, any combination of tasks within training system 704 may be used depending on what is required for each respective machine learning model. In at least one embodiment, one or more of machine learning models may already be trained and ready for deployment so machine learning models may not undergo any processing by training system 704 and may be implemented by deployment system 706.

In at least one embodiment, output model(s) 716 and/or pre-trained models 806 may include any types of machine learning models depending on embodiment. In at least one embodiment, and without limitation, machine learning models used by system 800 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipeline(s) 804 may include AI-assisted annotation. In at least one embodiment, labeled data 712 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 708 (or other data type used by machine learning models), there may be corresponding ground truth data generated by training system 704. In at least one embodiment, AI-assisted annotation may be performed as part of deployment pipeline(s) 810; either in addition to, or in lieu of, AI-assisted annotation included in training pipeline(s) 804. In at least one embodiment, system 800 may include a multi-layer platform that may include a software layer (e.g., software 718) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 702. In at least one embodiment, applications may then call or execute one or more services 720 for performing compute, AI, or visualization tasks associated with respective applications, and software 718 and/or services 720 may leverage hardware 722 to perform processing tasks in an effective and efficient manner.

In at least one embodiment, deployment system 706 may execute deployment pipelines 810. In at least one embodiment, deployment pipeline(s) 810 may include any number of applications that may be sequentially, non-sequentially, or otherwise applied to feedback data (and/or other data types), including AI-assisted annotation, as described above. In at least one embodiment, as described herein, a deployment pipeline(s) 810 for an individual device may be referred to as a virtual instrument for a device. In at least one embodiment, for a single device, there may be more than one deployment pipeline(s) 810 depending on information desired from data generated by a device.

In at least one embodiment, applications available for deployment pipeline(s) 810 may include any application that may be used for performing processing tasks on feedback data or other data from devices. In at least one embodiment, because various applications may share common image operations, in some embodiments, a data augmentation library (e.g., as one of services 720) may be used to accelerate these operations. In at least one embodiment, to avoid bottlenecks of conventional processing approaches that rely on CPU processing, parallel computing platform 830 may be used for GPU acceleration of these processing tasks.

In at least one embodiment, deployment system 706 may include a user interface (UI) 814 (e.g., a graphical user interface, a web interface, etc.) that may be used to select applications for inclusion in deployment pipeline(s) 810, arrange applications, modify or change applications or parameters or constructs thereof, use and interact with deployment pipeline(s) 810 during set-up and/or deployment, and/or to otherwise interact with deployment system 706. In at least one embodiment, although not illustrated with respect to training system 704, UI 814 (or a different user interface) may be used for selecting models for use in deployment system 706, for selecting models for training, or retraining, in training system 704, and/or for otherwise interacting with training system 704.

In at least one embodiment, pipeline manager 812 may be used, in addition to an application orchestration system 828, to manage interaction between applications or containers of deployment pipeline(s) 810 and services 720 and/or hardware 722. In at least one embodiment, pipeline manager 812 may be configured to facilitate interactions from application to application, from application to service 720, and/or from application or service to hardware 722. In at least one embodiment, although illustrated as included in software 718, this is not intended to be limiting, and in some examples pipeline manager 812 may be included in services 720. In at least one embodiment, application orchestration system 828 (e.g., Kubernetes, DOCKER, etc.) may include a container orchestration system that may group applications into containers as logical units for coordination, management, scaling, and deployment. In at least one embodiment, by associating applications from deployment pipeline(s) 810 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 812 and application orchestration system 828. In at least one embodiment, so long as an expected input and/or output of each container or application is known by a system (e.g., based on constructs of applications or containers), application orchestration system 828 and/or pipeline manager 812 may facilitate communication among and between, and sharing of resources among and between, each of the applications or containers. In at least one embodiment, because one or more of applications or containers in deployment pipeline(s) 810 may share the same services and resources, application orchestration system 828 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 828) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 720 leveraged and shared by applications or containers in deployment system 706 may include compute service(s) 816, collaborative content creation service(s) 817, AI service(s) 818, simulation service(s) 819, visualization service(s) 820, and/or other service types. In at least one embodiment, applications may call (e.g., execute) one or more of services 720 to perform processing operations for an application. In at least one embodiment, compute service(s) 816 may be leveraged by applications to perform super-computing or other high-performance computing (HPC) tasks. In at least one embodiment, compute service(s) 816 may be leveraged to perform parallel processing (e.g., using a parallel computing platform 830) for processing data through one or more of applications and/or one or more tasks of a single application, substantially simultaneously. In at least one embodiment, parallel computing platform 830 (e.g., NVIDIA's CUDA®) may enable general purpose computing on GPUs (GPGPU) (e.g., GPUs/graphics 822). In at least one embodiment, a software layer of parallel computing platform 830 may provide access to virtual instruction sets and parallel computational elements of GPUs, for execution of compute kernels. In at least one embodiment, parallel computing platform 830 may include memory and, in some embodiments, a memory may be shared between and among multiple containers and/or between and among different processing tasks within a single container. In at least one embodiment, inter-process communication (IPC) calls may be generated for multiple containers and/or for multiple processes within a container to use same data from a shared segment of memory of parallel computing platform 830 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI service(s) 818 may be leveraged to perform inferencing services for executing machine learning model(s) associated with applications (e.g., tasked with performing one or more processing tasks of an application). In at least one embodiment, AI service(s) 818 may leverage AI system(s) 824 to execute machine learning model(s) (e.g., neural networks, such as CNNs) for segmentation, reconstruction, object detection, feature detection, classification, and/or other inferencing tasks. In at least one embodiment, applications of deployment pipeline(s) 810 may use one or more of output model(s) 716 from training system 704 and/or other models of applications to perform inference on imaging data (e.g., DICOM data, RIS data, CIS data, REST compliant data, RPC data, raw data, etc.). For example, DICOM adapter 802b may be used to access DICOM data. In at least one embodiment, two or more examples of inferencing using application orchestration system 828 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 828 may distribute resources (e.g., services 720 and/or hardware 722) based on priority paths for different inferencing tasks of AI service(s) 818.

In at least one embodiment, shared storage may be mounted to AI service(s) 818 within system 800. In at least one embodiment, shared storage may operate as a cache (or other storage device type) and may be used to process inference requests from applications. In at least one embodiment, when an inference request is submitted, a request may be received by a set of API instances of deployment system 706, and one or more instances may be selected (e.g., for best fit, for load balancing, etc.) to process a request. In at least one embodiment, to process a request, a request may be entered into a database, a machine learning model may be located from model registry 724 if not already in a cache, a validation step may ensure an appropriate machine learning model is loaded into a cache (e.g., shared storage), and/or a copy of a model may be saved to a cache. In at least one embodiment, the scheduler (e.g., of pipeline manager 812) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel-level segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 720 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 826, and an inference service may perform inferencing on a GPU.

In at least one embodiment, visualization service(s) 820 may be leveraged to generate visualizations for viewing outputs of applications and/or deployment pipeline(s) 810. In at least one embodiment, GPUs/graphics 822 may be leveraged by visualization service(s) 820 to generate visualizations. In at least one embodiment, rendering effects, such as ray-tracing or other light transport simulation techniques, may be implemented by visualization service(s) 820 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization service(s) 820 may include an internal visualizer, cinematics, and/or other rendering or image processing capabilities or functionality (e.g., ray tracing, rasterization, internal optics, etc.).

In at least one embodiment, hardware 722 may include GPUs/graphics 822, AI system(s) 824, cloud 826, and/or any other hardware used for executing training system 704 and/or deployment system 706. In at least one embodiment, GPUs/graphics 822 (e.g., NVIDIA's TESLA® and/or QUADRO® GPUs) may include any number of GPUs that may be used for executing processing tasks of compute service(s) 816, collaborative content creation service(s) 817, AI service(s) 818, simulation service(s) 819, visualization service(s) 820, other services, and/or any of features or functionality of software 718. For example, with respect to AI service(s) 818, GPUs/graphics 822 may be used to perform pre-processing on imaging data (or other data types used by machine learning models), post-processing on outputs of machine learning models, and/or to perform inferencing (e.g., to execute machine learning models). In at least one embodiment, cloud 826, AI system(s) 824, and/or other components of system 800 may use GPUs/graphics 822. In at least one embodiment, cloud 826 may include a GPU-optimized platform for deep learning tasks. In at least one embodiment, AI system(s) 824 may use GPUs, and cloud 826—or at least a portion tasked with deep learning or inferencing—may be executed using one or more AI system(s) s 824. As such, although hardware 722 is illustrated as discrete components, this is not intended to be limiting, and any components of hardware 722 may be combined with, or leveraged by, any other components of hardware 722.

In at least one embodiment, AI system(s) 824 may include a purpose-built computing system (e.g., a super-computer or an HPC) configured for inferencing, deep learning, machine learning, and/or other artificial intelligence tasks. In at least one embodiment, AI system(s) 824 (e.g., NVIDIA's DGX™) may include GPU-optimized software (e.g., a software stack) that may be executed using a plurality of GPUs/graphics 822, in addition to CPUs, RAM, storage, and/or other components, features, or functionality. In at least one embodiment, one or more AI system(s) s 824 may be implemented in cloud 826 (e.g., in a data center) for performing some or all of AI-based processing tasks of system 800.

In at least one embodiment, cloud 826 may include a GPU-accelerated infrastructure (e.g., NVIDIA's NGC™) that may provide a GPU-optimized platform for executing processing tasks of system 800. In at least one embodiment, cloud 826 may include an AI system(s) 824 for performing one or more of AI-based tasks of system 800 (e.g., as a hardware abstraction and scaling platform). In at least one embodiment, cloud 826 may integrate with application orchestration system 828 leveraging multiple GPUs to enable seamless scaling and load balancing between and among applications and services 720. In at least one embodiment, cloud 826 may be tasked with executing at least some of services 720 of system 800, including compute service(s) 816, AI service(s) 818, and/or visualization service(s) 820, as described herein. In at least one embodiment, cloud 826 may perform small and large batch inference (e.g., executing NVIDIA's TensorRT™), provide an accelerated parallel computing platform 830 (e.g., NVIDIA's CUDA®), execute application orchestration system 828 (e.g., KUBERNETES), provide a graphics rendering API and platform (e.g., for ray-tracing, 2D graphics, 3D graphics, and/or other rendering techniques to produce higher quality cinematics), and/or may provide other functionality for system 800. In at least one embodiment, parallel computing platform 830 may include an API.

In at least one embodiment, in an effort to preserve patient confidentiality (e.g., where patient data or records are to be used off-premises), cloud 826 may include a registry, such as a deep learning container registry. In at least one embodiment, a registry may store containers for instantiations of applications that may perform pre-processing, post-processing, or other processing tasks on patient data. In at least one embodiment, cloud 826 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

### Neural Network Training and Deployment

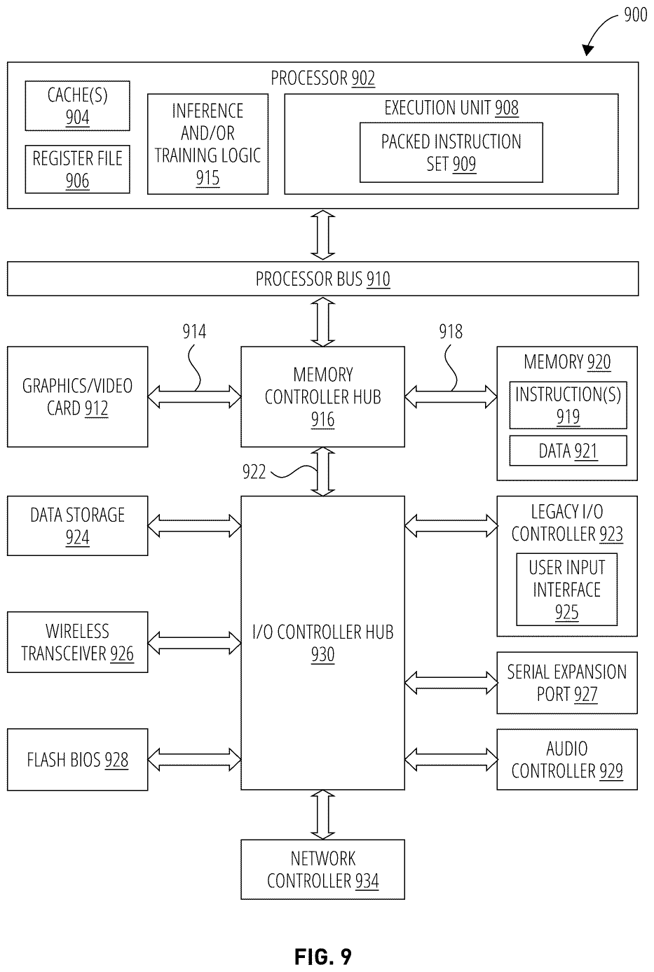

FIG. 9 is a block diagram illustrating an exemplary computer system 900, which may be a system with interconnected devices and components, a system-on-a-chip (SOC) or some combination thereof formed with a processor that may include execution units to execute an instruction, according to at least one embodiment. The system 100 described above with respect to FIG. 1 may include one or more of the example computer system 900. In at least one embodiment, computer system 900 may include, without limitation, a component, such as a processor 902 to employ execution units including logic to perform algorithms for process data, in accordance with present disclosure, such as in embodiment described herein. In at least one embodiment, computer system 900 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 900 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, edge devices, Internet-of-Things (“IoT”) devices, or any other system that may perform one or more instructions in accordance with at least one embodiment.

In at least one embodiment, computer system 900 may include, without limitation, processor 902 that may include, without limitation, one or more execution units 908 to perform machine learning model training and/or inferencing according to techniques described herein. In at least one embodiment, computer system 900 is a single processor desktop or server system, but in another embodiment, computer system 900 may be a multiprocessor system. In at least one embodiment, processor 902 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 902 may be coupled to a processor bus 910 that may transmit data signals between processor 902 and other components in computer system 900.

In at least one embodiment, processor 902 may include, without limitation, a Level 1 (“L1”) internal cache memory (“cache”) 904. In at least one embodiment, processor 902 may have a single internal cache or multiple levels of internal cache. In at least one embodiment, cache memory may reside external to processor 902. Other embodiments may also include a combination of both internal and external caches depending on particular implementation and needs.

In at least one embodiment, processor 902 may include, without limitation, a Level 2 (“L2”) internal cache memory (“cache”) 904. The L2 cache can serve as a secondary, larger, and somewhat slower cache compared to the L1 cache that is still faster than accessing the main memory (e.g., via the memory controller hub 916). Thus, the L2 cache can enhance performance by reducing the time the processor spends accessing the main memory. In at least one embodiment, processor 902 may have a single internal L2 cache or multiple levels of internal cache. In embodiments where the processor 902 is a multi-core processor, the L2 cache can be shared among multiple cores of processor 902, providing a larger, intermediate level of cache memory for more than one processing core. In at least one embodiment, L2 cache memory may reside external to processor 902.

In at least one embodiment, processor 902 may include, without limitation, a Level 3 (“L3”) internal cache memory (“cache”) 904. The L3 cache can serve as a tertiary, larger, and slower cache compared to both the L1 and L2 caches. The L3 cache can enhance performance by reducing the time the processor spends accessing the main memory. The L3 cache can be shared among multiple cores of processor 902, providing a larger pool of fast-access memory for data for the processor cores. In at least one embodiment, processor 902 may have a single internal L3 cache or multiple levels of internal cache. In at least one embodiment, L3 cache memory may reside external to processor 902. Other embodiments may also include any combination of internal or external L1, L2, and/or L3 caches depending on particular implementation and needs. In at least one embodiment, register file 906 may store different types of data in various registers including, without limitation, integer registers, floating point registers, status registers, and instruction pointer register.

In at least one embodiment, execution unit 908, including, without limitation, logic to perform integer and floating point operations, also resides in processor 902. In at least one embodiment, processor 902 may also include a microcode (“ucode”) read only memory (“ROM”) that stores microcode for certain macro instructions. In at least one embodiment, execution unit 908 may include logic to handle a packed instruction set 909. In at least one embodiment, by including packed instruction set 909 in an instruction set of a general-purpose processor 902, along with associated circuitry to execute instructions, operations used by many multimedia applications may be performed using packed data in a general-purpose processor 902. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 908 may also be used in microcontrollers, embedded processors, graphics devices, DSPs, and other types of logic circuits. In at least one embodiment, computer system 900 may include, without limitation, a memory 920. In at least one embodiment, memory 920 may be implemented as a Dynamic Random Access Memory (“DRAM”) device, a Static Random Access Memory (“SRAM”) device, flash memory device, or other memory device. In at least one embodiment, memory 920 may store instruction(s) 919 and/or data 921 represented by data signals that may be executed by processor 902.

In at least one embodiment, system logic chip may be coupled to processor bus 910 and memory 920. In at least one embodiment, system logic chip may include, without limitation, a memory controller hub (“MCH”) 916, and processor 902 may communicate with MCH 916 via processor bus 910. In at least one embodiment, MCH 916 may provide a high bandwidth memory path 918 to memory 920 for instruction and data storage and for storage of graphics commands, data and textures. In at least one embodiment, MCH 916 may direct data signals between processor 902, memory 920, and other components in computer system 900 and to bridge data signals between processor bus 910, memory 920, and a system I/O 922. In at least one embodiment, system logic chip may provide a graphics port for coupling to a graphics controller. In at least one embodiment, MCH 916 may be coupled to memory 920 through a high bandwidth memory path 918 and graphics/video card 912 may be coupled to MCH 916 through an Accelerated Graphics Port (“AGP”) interconnect 914.

In at least one embodiment, computer system 900 may use system I/O 922 that is a proprietary hub interface bus to couple MCH 916 to I/O controller hub (“ICH”) 930. In at least one embodiment, ICH 930 may provide direct connections to some I/O devices via a local I/O bus. In at least one embodiment, local I/O bus may include, without limitation, a high-speed I/O bus for connecting peripherals to memory 920, chipset, and processor 902. Examples may include, without limitation, an audio controller 929, a firmware hub (“flash BIOS”) 928, a wireless transceiver 926, a data storage 924, a legacy I/O controller 923 containing user input and keyboard interfaces 925, a serial expansion port 927, such as Universal Serial Bus (“USB”), and a network controller 934, which may include in some embodiments, a data processing unit. Data storage 924 may comprise a hard disk drive, a floppy disk drive, a CD-ROM device, a flash memory device, or other mass storage device.

In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 900 are interconnected using compute express link (CXL) interconnects.

Inference and/or training logic 915 are used to perform inferencing and/or training operations associated with one or more embodiments. The inference and/or training logic 915 may include same or similar features of training logic/hardware structure(s) 515. Details training logic/hardware structure(s) 515 are provided in conjunction with FIG. 5A and/or FIG. 5B. In at least one embodiment, inference and/or training logic 915 may be used in system FIG. 9 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

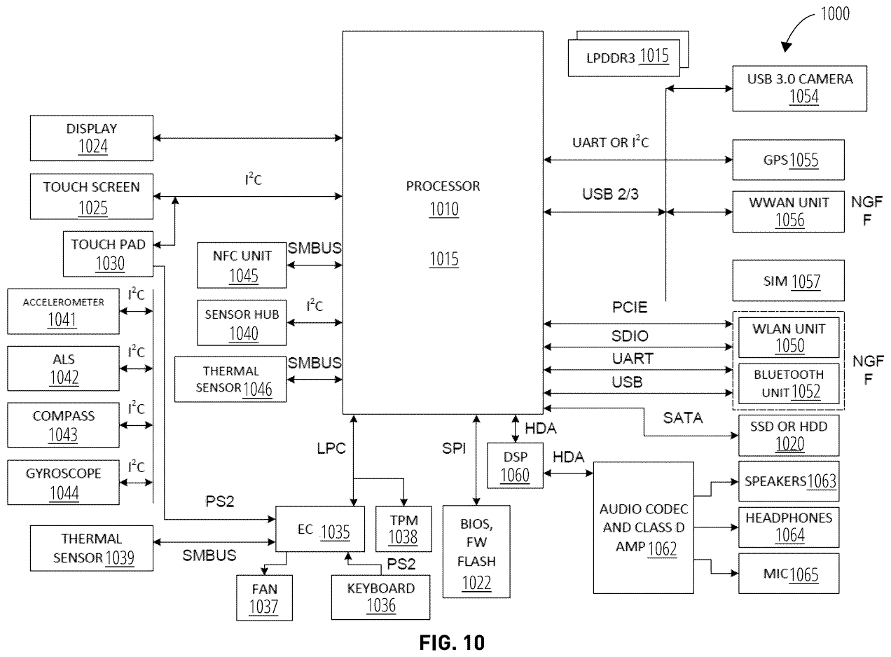

FIG. 10 is a block diagram illustrating an electronic device 1000 for utilizing a processor 1010, according to at least one embodiment. The system 100 described above with respect to FIG. 1 may include one or more of the example electronic device 1000. In at least one embodiment, electronic device 1000 may be, for example and without limitation, a notebook, a tower server, a rack server, a blade server, a laptop, a desktop, a tablet, a mobile device, a phone, an embedded computer, an edge device, an IoT device, or any other suitable electronic device.

In at least one embodiment, electronic device 1000 may include, without limitation, processor 1010 communicatively coupled to any suitable number or kind of components, peripherals, modules, or devices. In at least one embodiment, processor 1010 coupled using a bus or interface, such as a I2C bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 10 illustrates a system, which includes interconnected hardware devices or “chips”, whereas in other embodiments, FIG. 10 may illustrate an exemplary System on a Chip (“SoC”). In at least one embodiment, devices illustrated in FIG. 10 may be interconnected with proprietary interconnects, standardized interconnects (e.g., PCIe) or some combination thereof. In at least one embodiment, one or more components of FIG. 10 are interconnected using compute express link (CXL) interconnects.

In at least one embodiment, FIG. 10 may include a display 1024, a touch screen 1025, a touch pad 1030, a Near Field Communications unit (“NFC”) 1045, a sensor hub 1040, a thermal sensor 1046, an Express Chipset (“EC”) 1035, a Trusted Platform Module (“TPM”) 1038, BIOS/firmware/flash memory (“BIOS, FW Flash”) 1022, a DSP 1060, a drive 1020 such as a Solid State Disk (“SSD”) or a Hard Disk Drive (“HDD”), a wireless local area network unit (“WLAN”) 1050, a Bluetooth unit 1052, a Wireless Wide Area Network unit (“WWAN”) 1056, a Global Positioning System (GPS) 1055, a camera (“USB 3.0 camera”) 1054 such as a USB 3.0 camera, and/or a Low Power Double Data Rate (“LPDDR”) memory unit (“LPDDR3”) 1015 implemented in, for example, LPDDR3 standard. These components may each be implemented in any suitable manner.

In at least one embodiment, other components may be communicatively coupled to processor 1010 through components discussed above. In at least one embodiment, an accelerometer 1041, Ambient Light Sensor (“ALS”) 1042, compass 1043, and a gyroscope 1044 may be communicatively coupled to sensor hub 1040. In at least one embodiment, thermal sensor 1039, a fan 1037, a keyboard 1036, and a touch pad 1030 may be communicatively coupled to EC 1035. In at least one embodiment, speaker 1063, headphones 1064, and microphone (“mic”) 1065 may be communicatively coupled to an audio unit (“audio codec and class d amp”) 1062, which may in turn be communicatively coupled to DSP 1060. In at least one embodiment, audio unit 1062 may include, for example and without limitation, an audio coder/decoder (“codec”) and a class D amplifier. In at least one embodiment, SIM card (“SIM”) 1057 may be communicatively coupled to WWAN unit 1056. In at least one embodiment, components such as WLAN unit 1050 and Bluetooth unit 1052, as well as WWAN unit 1056 may be implemented in a Next Generation Form Factor (“NGFF”).

Inference and/or training logic/hardware structures 515 are used to perform inferencing and/or training operations associated with one or more embodiments. Details regarding training logic/hardware structure(s) 515 are provided in conjunction with FIG. 5A and/or FIG. 5B. In at least one embodiment, inference and/or training logic structures 515 may be used in system FIG. 10 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

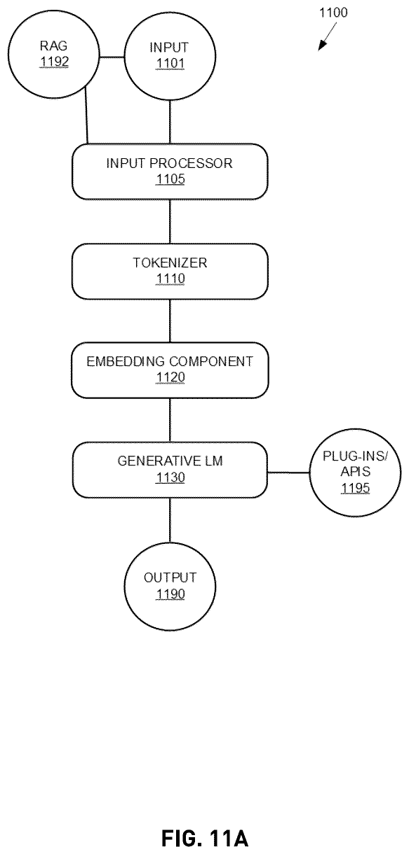

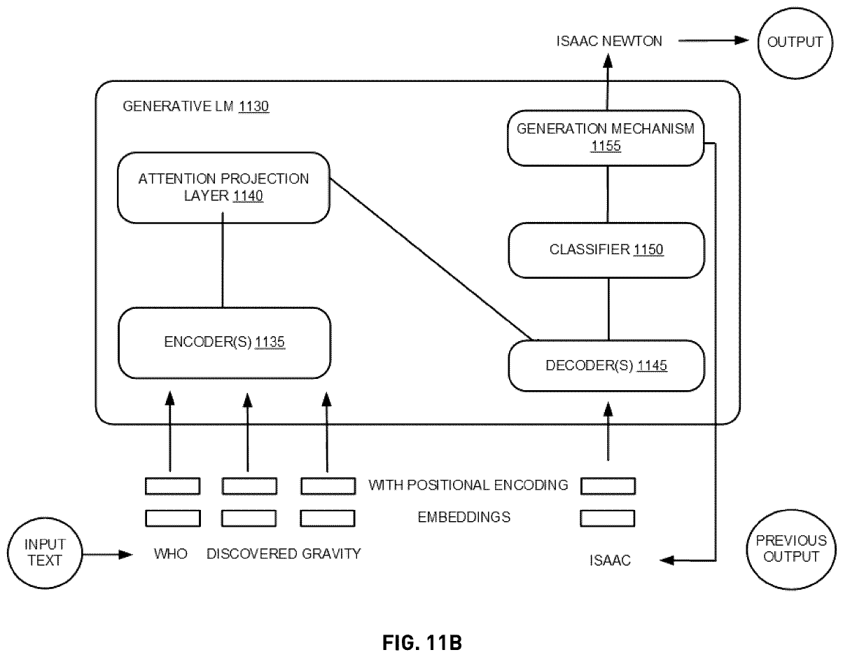

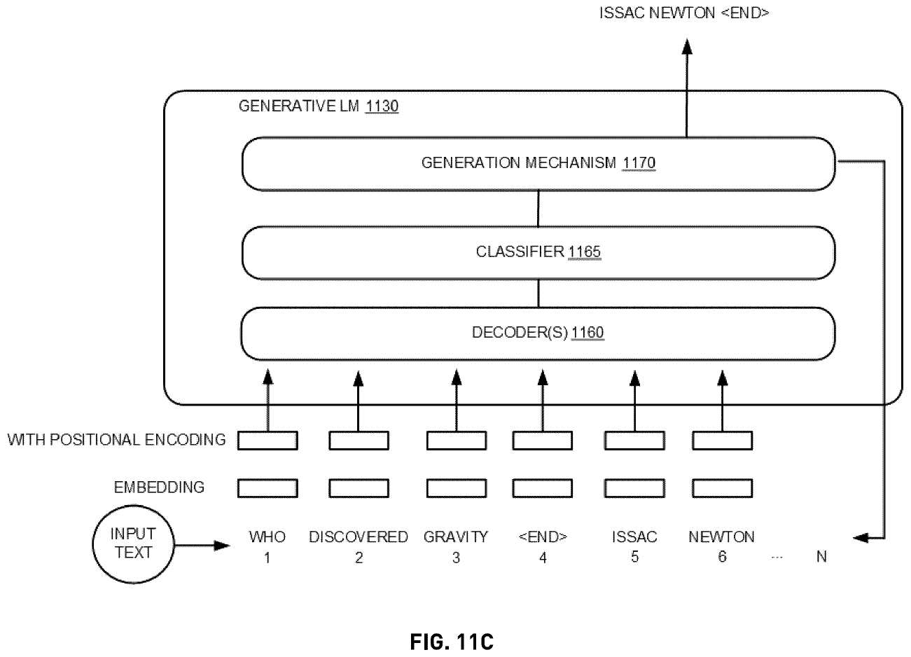

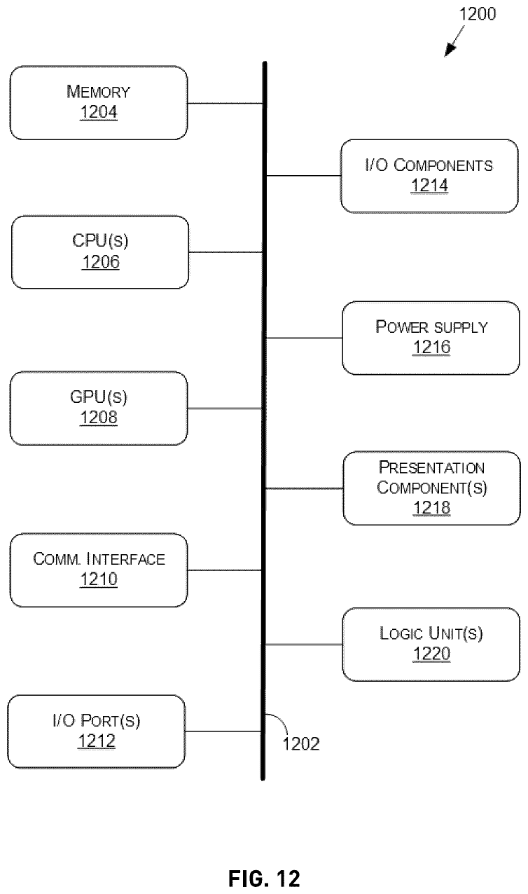

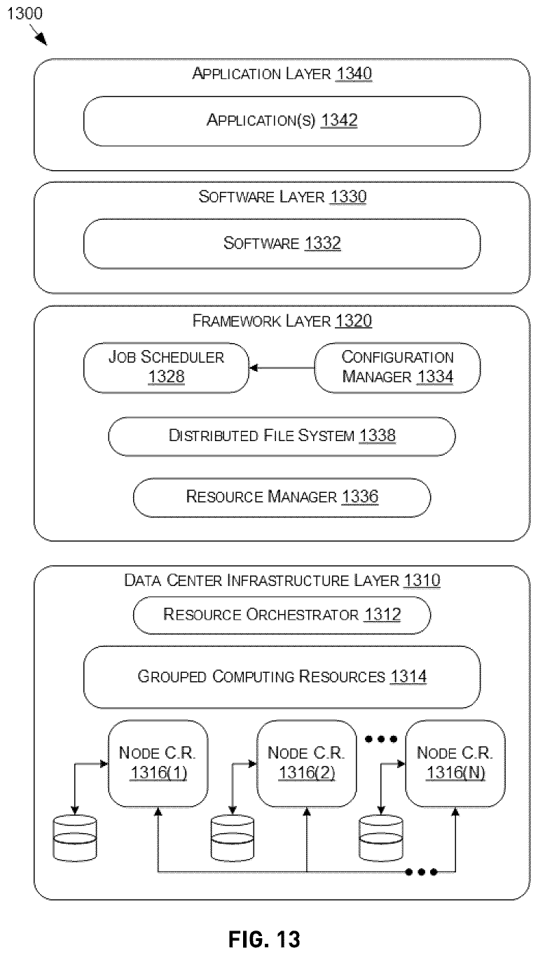

With reference to FIG. 1, FIG. 1 is an example system with a control plane and an HPC cluster, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. For example, in some embodiments, the system and methods described herein may be implemented using one or more generative language models (e.g., as described in FIGS. 11A-11C), one or more computing devices (e.g., as described in FIG. 12), and/or one or more data centers (e.g., as described in FIG. 13).

Now referring to FIGS. 3-4, each block of methods 300, 400, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), as a microservice via an application programming interface (API) or a plug-in to another product, to name a few. In addition, methods 300, 400 are described, by way of example, with respect to the system of FIG. 1. However, this method may additionally or alternatively be executed by any one system, or any combination of systems, including, but not limited to, those described herein.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as one or more large language models (LLMs), one or more small language models (SLMs), one or more vision language models (VLMs), one or more multi-modal language models, etc., systems for performing light transport simulation, systems for performing collaborative content creation for 3D assets (e.g., using universal scene descriptor (USD) data, such as Open-USD, and/or other data types), systems implemented at least partially using cloud computing resources, and/or other types of systems.

### Example Language Models

In at least some embodiments, language models, such as large language models (LLMs) and/or other types of generative artificial intelligence (AI) may be implemented. These may be implemented by an HPC cluster within a cloud-native container orchestration environment, such as that described within. These models may be capable of understanding, summarizing, translating, and/or otherwise generating text (e.g., natural language text, code, etc.), images, video, computer aided design (CAD) assets, omniverse and/or metaverse file information (e.g., in USD format), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/etc. may be implemented for summarizing textual data, analyzing and extracting insights from data (e.g., textual, image, video, etc.), and generating new text/image/video/etc. in user-specified styles, tones, and/or formats. The LLMs of the present disclosure may be used exclusively for text processing, in embodiments, whereas in other embodiments, multimodal LLMs may be implemented to accept, understand, and/or generate text along with other types of content like images, audio, and/or video. For example, vision language models (VLMs), or more generally multimodal language models, may be implemented to accept image, video, audio, textual, 3D design (e.g., CAD), and/or other inputs data types and/or to generate or output image, video, audio, textual, 3D design, and/or other output data types.

Various types of LLM/VLM/etc. architectures may be implemented in various embodiments. For example, different architectures may be implemented that use different techniques for understanding and generating outputs—such as text, audio, video, image, etc. In some embodiments, LLM architectures such as recurrent neural networks (RNNs) or long short-term memory networks (LSTMs) may be used, while in other embodiments transformer architectures—such as those that rely on self-attention mechanisms—may be used to understand and recognize relationships between words or tokens. One or more generative processing pipelines that include LLMs may also include one or more diffusion block(s) (e.g., denoisers). The language models of the present disclosure may include encoder and/or decoder block(s). For example, discriminative or encoder-only LLMs like BERT (Bidirectional Encoder Representations from Transformers) may be implemented for tasks that involve language comprehension such as classification, sentiment analysis, question answering, and named entity recognition. As another example, generative or decoder-only LLMs like GPT (Generative Pretrained Transformer) may be implemented for tasks that involve language and content generation such as text completion, story generation, and dialogue generation. LLMs that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the model(s).

In various embodiments, the LLMs/VLMs/etc. may be trained using unsupervised learning, in which an LLM learns patterns from large amounts of unlabeled text/audio/video/image/etc. data. Due to the extensive training, in embodiments, the models may not require task-specific or domain-specific training. LLMs that have undergone extensive pre-training on vast amounts of unlabeled text data may be referred to as foundation models and may be adept at a variety of tasks like question-answering, summarization, filling in missing information, and translation. Some LLMs may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/etc. of the present disclosure may be implemented using various model alignment techniques. For example, in some embodiments, guardrails may be implemented to identify improper or undesired inputs (e.g., prompts) and/or outputs of the models. In some non-limiting embodiments, the guardrails implemented may be similar to those described in U.S. Pat. App. No. 18,304,341, filed on Apr. 20, 2023, the contents of which are hereby incorporated by reference in their entirety. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/etc. of the present disclosure may be less likely to output language/text/audio/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 11A is a block diagram of an example generative language model system 1100 suitable for use in implementing at least some embodiments of the present disclosure. In the example illustrated in FIG. 11A, the generative language model system 1100 includes a retrieval augmented generation (RAG) component 1192, an input processor 1105, a tokenizer 1110, an embedding component 1120, plug-ins/APIs 1195, and a generative language model (LM) 1130 (which may include an LLM, a VLM, a multi-modal LM, etc.).

At a high level, the input processor 1105 may receive an input 1101 comprising text and/or other types of input data (e.g., audio data, video data, image data, sensor data (e.g., LIDAR, RADAR, ultrasonic, etc.), 3D design data, CAD data, universal scene descriptor (USD) data, etc.), depending on the architecture of the generative LM 1130. In some embodiments, the input 1101 includes plain text in the form of one or more sentences, paragraphs, and/or documents. Additionally or alternatively, the input 1101 may include numerical sequences, precomputed embeddings (e.g., word or sentence embeddings), and/or structured data (e.g., in tabular formats, JSON, or XML). In some implementations in which the generative LM 1130 is capable of processing multimodal inputs, the input 1101 may combine text with image data, audio data, and/or other types of input data, such as but not limited to those described herein. Taking raw input text as an example, the input processor 1105 may prepare raw input text in various ways. For example, the input processor 1105 may perform various types of text filtering to remove noise (e.g., special characters, punctuation, HTML tags, stopwords) from relevant textual content. In an example involving stopwords (common words that tend to carry little semantic meaning), the input processor 1105 may remove stopwords to reduce noise and focus the generative LM 1130 on more meaningful content. The input processor 1105 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1192 may be used to retrieve additional information to be used as part of the input 1101 or prompt. For example, in some embodiments, the input 1101 may be generated using the query or input to the model (e.g., a question, a request, etc.) in addition to data retrieved using the RAG component 1192. In some embodiments, the input processor 1105 may analyze the input 1101 and communicate with the RAG component 1192 (or the RAG component 1192 may be part of the input processor 1105, in embodiments) in order to identify relevant text and/or other data to provide to the generative LM 1130 as additional context or sources of information from which to identify the response, answer, or output 1190, generally. For example, where the input indicates that the user is interested in a desired tire pressure for a particular make and model of vehicle, the RAG component 1192 may retrieve-using a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1192 may retrieve a prior stored conversation history—or at least a summary thereof—and include the prior conversation history along with the current ask/request as part of the input 1101 to the generative LM 1130.

The tokenizer 1110 may segment the (e.g., processed) text into smaller units (tokens) for subsequent analysis and processing. The tokens may represent individual words, subwords, characters, etc., depending on the implementation. Word-based tokenization divides the text into individual words, treating each word as a separate token. Subword tokenization breaks down words into smaller meaningful units (e.g., prefixes, suffixes, stems), enabling the generative LM 1130 to understand morphological variations and handle out-of-vocabulary words more effectively. Character-based tokenization represents each character as a separate token, enabling the generative LM 1130 to process text at a fine-grained level. The choice of tokenization strategy may depend on factors such as the language being processed, the task at hand, and/or characteristics of the training dataset. As such, the tokenizer 1110 may convert the (e.g., processed) text into a structured format according to tokenization schema being implemented in the particular embodiment.

The embedding component 1120 may use any known embedding technique to transform discrete tokens into (e.g., dense, continuous vector) representations of semantic meaning. For example, the embedding component 1120 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1101 includes image data, the input processor 1101 may resize the image data to a standard size compatible with format of a corresponding input channel and/or may normalize pixel values to a common range (e.g., 0 to 1) to ensure a consistent representation, and the embedding component 1120 may encode the image data using any known technique (e.g., using one or more convolutional neural networks (CNNs) to extract visual features). In some implementations in which the input 1101 includes audio data, the input processor 1101 may resample an audio file to a consistent sampling rate for uniform processing, and the embedding component 1120 may use any known technique to extract and encode audio features—such as in the form of a spectrogram (e.g., a mel-spectrogram). In some implementations in which the input 1101 includes video data, the input processor 1101 may extract frames or apply resizing to extracted frames, and the embedding component 1120 may extract features such as optical flow embeddings or video embeddings and/or may encode temporal information or sequences of frames. In some implementations in which the input 1101 includes multimodal data, the embedding component 1120 may fuse representations of the different types of data (e.g., text, image, audio) using techniques like early fusion (concatenation), late fusion (sequential processing), attention-based fusion, etc.

The generative LM 1130 and/or other components of the generative LLM system 1100 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multimodal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 1120 may apply an encoded representation of the input 1101 to the generative LM 1130, and the generative LM 1130 may process the encoded representation of the input 1101 to generate an output 1190, which may include responsive text and/or other types of data.

As described herein, in some embodiments, the generative LM 1130 may be configured to access or use—or capable of accessing or using—plug-ins/APIs 1195 (which may include one or more plug-ins, application programming interfaces (APIs), databases, data stores, repositories, etc.). For example, for certain tasks or operations that the generative LM 1130 is not ideally suited for, the model may have instructions (e.g., as a result of training, and/or based on instructions in a given prompt, such as those retrieved using the RAG component 1192) to access one or more plug-ins/APIs 1195 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1195 to the plug-in/API 1195, the plug-in/API 1195 may process the information and return an answer to the generative LM 1130, and the generative LM 1130 may use the response to generate the output 1190. This process may be repeated—e.g., recursively—for any number of iterations and using any number of plug-ins/APIs 1195 until an output 1190 that addresses each ask/question/request/process/operation/etc. from the input 1101 can be generated. As such, the model(s) may not only rely on its own knowledge from training on a large dataset(s) and/or from data retrieved using the RAG component 1192, but also on the expertise or optimized nature of one or more external resources—such as the plug-ins/APIs 1195.

FIG. 11B is a block diagram of an example implementation in which the generative LM 1130 includes a transformer encoder-decoder. For example, assume input text such as “Who discovered gravity” is tokenized (e.g., by the tokenizer 1110 of FIG. 11A) into tokens such as words, and each token is encoded (e.g., by the embedding component 1120 of FIG. 911A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1135 of the generative LM 1130.

In an example implementation, the encoder(s) 1135 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1140 may convert the context vector into attention vectors (keys and values) for the decoder(s) 1145.

In an example implementation, the decoder(s) 1145 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1135, in an example transformer architecture, each token (e.g., word) flows through a separate path in the decoder(s) 1145. During a first pass, the decoder(s) 1145, a classifier 1150, and a generation mechanism 1155 may generate a first token, and the generation mechanism 1155 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1145 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 1135, except that it creates its queries from the layer below it and takes the keys and values (e.g., matrix) from the output of the encoder(s) 1135.

As such, the decoder(s) 1145 may output some decoded (e.g., vector) representation of the input being applied during a particular pass. The classifier 1150 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1155 may select or sample a word or token based on a corresponding predicted probability (e.g., select the word with the highest predicted probability) and append it to the output from a previous pass, generating each word or token sequentially. The generation mechanism 1155 may repeat the process, triggering successive decoder inputs and corresponding predictions until selecting or sampling a symbol or token that represents the end of the response, at which point, the generation mechanism 1155 may output the generated response.

FIG. 11C is a block diagram of an example implementation in which the generative LM 1130 includes a decoder-only transformer architecture. For example, the decoder(s) 1160 of FIG. 11C may operate similarly as the decoder(s) 1145 of FIG. 11B except each of the decoder(s) 1160 of FIG. 11C omits the encoder-decoder self-attention layer (since there is no encoder in this implementation). As such, the decoder(s) 1160 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1160. As with the decoder(s) 1145 of FIG. 11B, each token (e.g., word) may flow through a separate path in the decoder(s) 1160, and the decoder(s) 1160, a classifier 1165, and a generation mechanism 1170 may use auto-regression to sequentially generate one token at a time until predicting a symbol or token that represents the end of the response. The classifier 1165 and the generation mechanism 1170 may operate similarly as the classifier 1150 and the generation mechanism 1155 of FIG. 11B, with the generation mechanism 1170 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 12 is a block diagram of an example computing device(s) 1200 suitable for use in implementing some embodiments of the present disclosure. The example computing device(s) 1200 may perform any of the operations of the interface 120, as described herein. Computing device 1200 may include an interconnect system 1202 that directly or indirectly couples the following devices: memory 1204, one or more central processing units (CPUs) 1206, one or more graphics processing units (GPUs) 1208, a communication interface 1210, input/output (I/O) ports 1212, input/output components 1214, a power supply 1216, one or more presentation components 1218 (e.g., display(s)), and one or more logic units 1220. In at least one embodiment, the computing device(s) 1200 may comprise one or more virtual machines (VMs), and/or any of the components thereof may comprise virtual components (e.g., virtual hardware components). For non-limiting examples, one or more of the GPUs 1208 may comprise one or more vGPUs, one or more of the CPUs 1206 may comprise one or more vCPUs, and/or one or more of the logic units 1220 may comprise one or more virtual logic units. As such, a computing device(s) 1200 may include discrete components (e.g., a full GPU dedicated to the computing device 1200), virtual components (e.g., a portion of a GPU dedicated to the computing device 1200), or a combination thereof.

Although the various blocks of FIG. 12 are shown as connected via the interconnect system 1202 with lines, this is not intended to be limiting and is for clarity only. For example, in some embodiments, a presentation component 1218, such as a display device, may be considered an I/O component 1214 (e.g., if the display is a touch screen). As another example, the CPUs 1206 and/or GPUs 1208 may include memory (e.g., the memory 1204 may be representative of a storage device in addition to the memory of the GPUs 1208, the CPUs 1206, and/or other components). As such, the computing device of FIG. 12 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 12.

The interconnect system 1202 may represent one or more links or busses, such as an address bus, a data bus, a control bus, or a combination thereof. The interconnect system 1202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1206 may be directly connected to the memory 1204. Further, the CPU 1206 may be directly connected to the GPU 1208. Where there is direct, or point-to-point connection between components, the interconnect system 1202 may include a PCIe link to carry out the connection. In these examples, a PCI bus need not be included in the computing device 1200.

The memory 1204 may include any of a variety of computer-readable media. The computer-readable media may be any available media that may be accessed by the computing device 1200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1206 may be configured to execute at least some of the computer-readable instructions to control one or more components of the computing device 1200 to perform one or more of the methods and/or processes described herein. The CPU(s) 1206 may each include one or more cores (e.g., one, two, four, eight, twenty-eight, seventy-two, etc.) that are capable of handling a multitude of software threads simultaneously. The CPU(s) 1206 may include any type of processor, and may include different types of processors depending on the type of computing device 1200 implemented (e.g., processors with fewer cores for mobile devices and processors with more cores for servers). For example, depending on the type of computing device 1200, the processor may be an Advanced RISC Machines (ARM) processor implemented using Reduced Instruction Set Computing (RISC) or an x86 processor implemented using Complex Instruction Set Computing (CISC). The computing device 1200 may include one or more CPUs 1206 in addition to one or more microprocessors or supplementary co-processors, such as math co-processors.

In addition to or alternatively from the CPU(s) 1206, the GPU(s) 1208 may be configured to execute at least some of the computer-readable instructions to control one or more components of the computing device 1200 to perform one or more of the methods and/or processes described herein. One or more of the GPU(s) 1208 may be an integrated GPU (e.g., with one or more of the CPU(s) 1206 and/or one or more of the GPU(s) 1208 may be a discrete GPU. In embodiments, one or more of the GPU(s) 1208 may be a coprocessor of one or more of the CPU(s) 1206. The GPU(s) 1208 may be used by the computing device 1200 to render graphics (e.g., 3D graphics) or perform general purpose computations. For example, the GPU(s) 1208 may be used for General-Purpose computing on GPUs (GPGPU). The GPU(s) 1208 may include hundreds or thousands of cores that are capable of handling hundreds or thousands of software threads simultaneously. The GPU(s) 1208 may generate pixel data for output images in response to rendering commands (e.g., rendering commands from the CPU(s) 1206 received via a host interface). The GPU(s) 1208 may include graphics memory, such as display memory, for storing pixel data or any other suitable data, such as GPGPU data. The display memory may be included as part of the memory 1204. The GPU(s) 1208 may include two or more GPUs operating in parallel (e.g., via a link). The link may directly connect the GPUs (e.g., using NVLINK) or may connect the GPUs through a switch (e.g., using NVSwitch). When combined together, each GPU 1208 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1206 and/or the GPU(s) 1208, the logic unit(s) 1220 may be configured to execute at least some of the computer-readable instructions to control one or more components of the computing device 1200 to perform one or more of the methods and/or processes described herein. In embodiments, the CPU(s) 1206, the GPU(s) 1208, and/or the logic unit(s) 1220 may discretely or jointly perform any combination of the methods, processes and/or portions thereof. One or more of the logic units 1220 may be part of and/or integrated in one or more of the CPU(s) 1206 and/or the GPU(s) 1208 and/or one or more of the logic units 1220 may be discrete components or otherwise external to the CPU(s) 1206 and/or the GPU(s) 1208. In embodiments, one or more of the logic units 1220 may be a coprocessor of one or more of the CPU(s) 1206 and/or one or more of the GPU(s) 1208.

Examples of the logic unit(s) 1220 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs), one or more decoupled accelerators (e.g., decoupled lookup table (DLUT) accelerators), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1210 may include one or more receivers, transmitters, and/or transceivers that allow the computing device 1200 to communicate with other computing devices via an electronic communication network, included wired and/or wireless communications. The communication interface 1210 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1220 and/or communication interface 1210 may include one or more data processing units (DPUs) to transmit data received over a network and/or through interconnect system 1202 directly to (e.g., a memory of) one or more GPU(s) 1208.

The I/O ports 1212 may allow the computing device 1200 to be logically coupled to other devices including the I/O components 1214, the presentation component(s) 1218, and/or other components, some of which may be built in to (e.g., integrated in) the computing device 1200. Illustrative I/O components 1214 include a microphone, mouse, keyboard, joystick, game pad, game controller, satellite dish, scanner, printer, wireless device, etc. The I/O components 1214 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1200. The computing device 1200 may be include depth cameras, such as stereoscopic camera systems, infrared camera systems, RGB camera systems, touchscreen technology, and combinations of these, for gesture detection and recognition. Additionally, the computing device 1200 may include accelerometers or gyroscopes (e.g., as part of an inertia measurement unit (IMU)) that allow detection of motion. In some examples, the output of the accelerometers or gyroscopes may be used by the computing device 1200 to render immersive augmented reality or virtual reality.

The power supply 1216 may include a hard-wired power supply, a battery power supply, or a combination thereof. The power supply 1216 may provide power to the computing device 1200 to allow the components of the computing device 1200 to operate.

The presentation component(s) 1218 may include a display (e.g., a monitor, a touch screen, a television screen, a heads-up-display (HUD), other display types, or a combination thereof), speakers, and/or other presentation components. The presentation component(s) 1218 may receive data from other components (e.g., the GPU(s) 1208, the CPU(s) 1206, DPUs, etc.), and output the data (e.g., as an image, video, sound, etc.).

### Example Data Center

FIG. 13 illustrates an example data center 1300 that may be used in at least one embodiments of the present disclosure. In at least one embodiment, the example data center 1300 may be an HPC cluster 130 as described herein. In another embodiment, the example data center 1300 may perform one or more operations of the interface 120 as described herein. The data center 1300 may include a data center infrastructure layer 1310, a framework layer 1320, a software layer 1330, and/or an application layer 1340.

As shown in FIG. 13, the data center infrastructure layer 1310 may include a resource orchestrator 1312, grouped computing resources 1314, and node computing resources (“node C.R.s”) 1316(1)-1316(N), where “N” represents any whole, positive integer. In at least one embodiment, node C.R.s 1316(1)-1316(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1316(1)-1316(N) may correspond to a server having one or more of the above-mentioned computing resources. In addition, in some embodiments, the node C.R.s 1316(1)-13161(N) may include one or more virtual components, such as vGPUs, vCPUs, and/or the like, and/or one or more of the node C.R.s 1316(1)-1316(N) may correspond to a virtual machine (VM).

In at least one embodiment, grouped computing resources 1314 may include separate groupings of node C.R.s 1316 housed within one or more racks (not shown), or many racks housed in data centers at various geographical locations (also not shown). Separate groupings of node C.R.s 1316 within grouped computing resources 1314 may include grouped compute, network, memory or storage resources that may be configured or allocated to support one or more workloads. In at least one embodiment, several node C.R.s 1316 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1312 may configure or otherwise control one or more node C.R.s 1316(1)-1316(N) and/or grouped computing resources 1314. In at least one embodiment, resource orchestrator 1312 may include a software design infrastructure (SDI) management entity for the data center 1300. The resource orchestrator 1312 may include hardware, software, or some combination thereof.

In at least one embodiment, as shown in FIG. 13, framework layer 1320 may include a job scheduler 1328, a configuration manager 1334, a resource manager 1336, and/or a distributed file system 1338. The framework layer 1320 may include a framework to support software 1332 of software layer 1330 and/or one or more application(s) 1342 of application layer 1340. The software 1332 or application(s) 1342 may respectively include web-based service software or applications, such as those provided by Amazon Web Services, Google Cloud and Microsoft Azure. The framework layer 1320 may be, but is not limited to, a type of free and open-source software web application framework such as Apache Spark™ (hereinafter “Spark”) that may use distributed file system 1338 for large-scale data processing (e.g., “big data”). In at least one embodiment, job scheduler 1328 may include a Spark driver to facilitate scheduling of workloads supported by various layers of data center 1300. The configuration manager 1334 may be capable of configuring different layers such as software layer 1330 and framework layer 1320 including Spark and distributed file system 1338 for supporting large-scale data processing. The resource manager 1336 may be capable of managing clustered or grouped computing resources mapped to or allocated for support of distributed file system 1338 and job scheduler 1328. In at least one embodiment, clustered or grouped computing resources may include grouped computing resource 1314 at data center infrastructure layer 1310. The resource manager 1336 may coordinate with resource orchestrator 1312 to manage these mapped or allocated computing resources.

In at least one embodiment, software 1332 included in software layer 1330 may include software used by at least portions of node C.R.s 1316(1)-1316(N), grouped computing resources 1314, and/or distributed file system 1338 of framework layer 1320. One or more types of software may include, but are not limited to, Internet web page search software, e-mail virus scan software, database software, and streaming video content software.

In at least one embodiment, application(s) 1342 included in application layer 1340 may include one or more types of applications used by at least portions of node C.R.s 1316(1)-1316(N), grouped computing resources 1314, and/or distributed file system 1338 of framework layer 1320. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1334, resource manager 1336, and resource orchestrator 1312 may implement any number and type of self-modifying actions based on any amount and type of data acquired in any technically feasible fashion. Self-modifying actions may relieve a data center operator of data center 1300 from making possibly bad configuration decisions and possibly avoiding underutilized and/or poor performing portions of a data center.

The data center 1300 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1300. In at least one embodiment, trained or deployed machine learning models corresponding to one or more neural networks may be used to infer or predict information using resources described above with respect to the data center 1300 by using weight parameters calculated through one or more training techniques, such as but not limited to those described herein.

In at least one embodiment, the data center 1300 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. One example of a suitable network environment is a cloud-native container orchestration environment, such as Kubernetes®. The client devices, servers, and/or other device types (e.g., each device) may be implemented on one or more instances of the computing device(s) 1200 of FIG. 12—e.g., each device may include similar components, features, and/or functionality of the computing device(s) 1200. In addition, where backend devices (e.g., servers, NAS, etc.) are implemented, the backend devices may be included as part of a data center 1300, an example of which is described in more detail herein with respect to FIG. 13.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1200 described herein with respect to FIG. 12. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two but can be more when so indicated either explicitly or by context. Further, unless stated otherwise or otherwise clear from context, the phrase “based on” means “based at least in part on” or “based at least on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, in some embodiments, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
receiving, from a container orchestration platform, a batch of one or more first job requests to be performed by a high-performance computing (HPC) cluster;
translating the batch of one or more first job requests into one or more second job requests, wherein the one or more second job requests are interpretable by a scheduler corresponding to the HPC cluster; and
sending the one or more second job requests to the scheduler.

2. The method of claim 1, wherein the container orchestration platform is a multi-tenant control plane configured to manage isolated clusters of resources.

3. The method of claim 1, further comprising:
determining one or more second job statuses corresponding to the one or more second job requests;
translating the one or more second job statuses to one or more first job statuses corresponding to the one or more first job requests; and
sending the one or more first job statuses to a key-value store maintained by the container orchestration platform configured to orchestrate containerized workloads.

4. The method of claim 1, wherein the one or more first job requests correspond to operations associated with training an artificial intelligence (AI) model.

5. The method of claim 1, wherein the one or more second job requests are generated based on a topology of the HPC cluster.

6. The method of claim 1, further comprising:
detecting an event associated with execution of the one or more second job requests within the HPC cluster; and
updating a state of one or more custom resources allocated by the container orchestration platform for the batch of one or more first job requests that map to the one or more second job requests, wherein the updated state of the one or more custom resources provides notification to the container orchestration platform of the event.

7. The method of claim 1, wherein the one or more first job requests specify at least one of a container image, arguments for an entry point of the container image, one or more environment variables, or resource requirements of a submitted workload.

8. A device comprising:
one or more processors; and
a memory storing instructions that, when executed by the one or more processors, cause the device to:
receive, from a container orchestration platform, a batch of one or more first job requests to be performed by a high-performance computing (HPC) cluster;
translate the batch of one or more first job requests into one or more second job requests, wherein the one or more second job requests are interpretable by a scheduler corresponding to the HPC cluster; and
send the one or more second job requests to the scheduler.

9. The device of claim 8, wherein the container orchestration platform is a multi-tenant control plane configured to manage isolated clusters of resources.

10. The device of claim 8, wherein the instructions further cause the device to:
determine one or more second job statuses corresponding to the one or more second job requests;
translate the one or more second job statuses to one or more first job statuses corresponding to the one or more first job requests; and
send the one or more first job statuses to a key-value store maintained by the container orchestration platform configured to orchestrate containerized workloads.

11. The device of claim 8, wherein the one or more first job requests correspond to operations associated with training an artificial intelligence (AI) model.

12. The device of claim 8, wherein the one or more second job requests are generated based on a topology of the HPC cluster.

13. The device of claim 8, wherein the instructions further cause the device to:
detect an event associated with execution of the one or more second job requests within the HPC cluster; and
update a state of one or more custom resources allocated by the container orchestration platform for the batch of one or more first job requests that map to the one or more second job requests, wherein the updated state of the one or more custom resources provides notification to the container orchestration platform of the event.

14. The device of claim 8, wherein the one or more first job requests specify at least one of a container image, arguments for an entry point of the container image, one or more environment variables, or resource requirements of a submitted workload.

15. A system comprising:
a container orchestration platform configured to operate within a cloud-native container orchestration environment;
a high-performance computing (HPC) cluster; and
an interface between the container orchestration platform and the HPC cluster, wherein the interface is configured to:
receive, from the container orchestration platform, a batch of one or more first job requests to be performed by the high-performance computing (HPC) cluster;
translate the batch of one or more first job requests into one or more second job requests, wherein the one or more second job requests are interpretable by a scheduler for the HPC cluster; and
send the one or more second job requests to the scheduler.

16. The system of claim 15, wherein the interface is integrated within the container orchestration platform.

17. The system of claim 15, wherein the interface is further configured to:
determine one or more second job statuses corresponding to the one or more second job requests;
translate the one or more second job statuses to one or more first job statuses corresponding to the one or more first job requests; and
send the one or more first job statuses to a key-value store maintained by the container orchestration platform configured to orchestrate containerized workloads.

18. The system of claim 15, wherein the one or more first job requests correspond to operations associated with training an artificial intelligence (AI) model.

19. The system of claim 15, wherein the interface is further configured to:
detect an event associated with execution of the one or more second job requests within the HPC cluster; and
update a state of one or more custom resources allocated by the container orchestration platform for the batch of one or more first job requests that map to the one or more second job requests, wherein the updated state of the one or more custom resources provides notification to the container orchestration platform of the event.

20. The system of claim 15, wherein the one or more first job requests specify at least one of a container image, arguments for an entry point of the container image, one or more environment variables, or resource requirements of a submitted workload.
